(19) United States
(12) Patent Application Publication
(10) Pub. No.: US 2007/0245227 A1
(43) Pub. Date: Oct. 18, 2007

(54) Business Transaction Documentation System and Method

(75) Inventors: Packy Hyland, Westlake, OH (US); Alexander L. Guba, Lakewood, OH (US)

Correspondence Address: JACKSON & CO., LLP, 6114 LA SALLE AVENUE, #507, OAKLAND, CA, 94611-2802, US

(73) Assignee: WORKFLOW.COM, LLC, Westlake, OH (US)

(21) Appl. No.: 11/734,753

(22) Filed: Apr. 12, 2007

Related U.S. Application Data
(60) Provisional application No. 60/744,810, filed on Apr. 13, 2006.

(51) Int. Cl. G06F 17/00; G06Q 10/00; G06F 9/44

(52) U.S. Cl. 715/505; 705/1; 705/7; 715/507

(57) ABSTRACT

A transaction documentation method includes loading a form including one or more hotspots from an indexed database of an electronic system that includes one or more scanned paper forms or imported externally-residing existing electronic forms or combinations thereof. The loaded form is displayed on a portable processor-based device. A transaction-specific form is generated by editing the loaded form during a business transaction including capturing information at a hotspot. The transaction-specific form is saved as an image, and also the information captured at the hotspot is discretely stored to a database.

### CROSS-REFERENCE TO RELATED APPLICATIONS

This application claims the benefit of priority under 35 USC §119 to U.S. Provisional Patent Application No. 60/744,810 filed on Apr. 13, 2006, entitled “Business Transaction Documentation System and Method”, which is hereby incorporated by reference.

### BACKGROUND

The invention relates to a solution that manages documents electronically, eliminating the need for paper. The invention is applicable to electronic solutions for electronic health records, messaging and workflow, as well as consultations of many other kinds particularly involving professionals such as medical doctors, psychologists, lawyers, engineers, contractors, repair workers, installers, salespersons, and accountants, among others. Paper documents are preferably converted to electronic format, allowing creation, revision and storage of documents electronically. Electronic documents may also be filed within the software and retrieved with a click of a mouse or a tap of a stylus.

In particular embodiments of the invention, Hyperforms™ technology allows organizations to continue work processes that in the past involved substantial use of paper forms, and now may be performed in an electronic or more electronic environment. HyperForms™ technology allows organizations to work with their current scripts, orders and other forms on a tablet PC. Data fields may be automatically mapped using HyperForms™, and ‘favorites’ lists’ may be used for improved speed and accuracy. An engine may be used for tracking statuses of messages, orders and patient charts, and a HyperForms™ technology system is configurable and flexible.

### SUMMARY OF THE INVENTION

A method of documenting a business transaction is provided. A form that includes one or more hotspots is loaded from an electronic system that includes one or more scanned paper forms or imported, externally-residing existing electronic forms, or combinations thereof. The loaded form is displayed on a portable processor-based device. A transaction-specific form is generated by editing the loaded form during a business transaction, wherein the editing includes capturing information with a hotspot. The transaction-specific form is saved as an image, while the information captured with the hotspot is also discretely stored.

The method further includes the following in various embodiments. Pre-stored transaction-specific information may be automatically filled into the transaction-specific form. The transaction-specific information may include a customer's name, date of birth, or gender, or the current date, or combinations thereof. The transaction-specific information may be automatically filled into the form when a customer is selected from a customer list residing on the system.

Information may be captured into the form at a hotspot. The information may be captured when a user chooses among options from a preconfigured list of favorites provided at a hotspot. Text may be added at a hotspot that is also discretely saved into a database. The form may have one or more tick hotspots whereby a predetermined marking is inserted with a stylus tap, mouse click, hitting enter or other execution mechanism. Information may be added into the transaction-specific form as a result of executing the tick hotspot. The tick hotspot information that is added may also be saved into the database. Editing may be further performed at a link icon hotspot, image hotspot or audio hotspot. A link hotspot may be executed for retrieving another document or network location.

Alphanumeric or handwritten text may be added into the transaction specific form at an arbitrary location. One or more selected items may be extracted from the transaction-specific form for insertion into another document. Information inserted at a hotspot may be extracted, stored discretely in the database and used to create a formatted note or to fill another document.

New hotspots may be created within a transaction-specific form during a business transaction. In addition, data may be communicated from the transaction-specific form to another processor-based device.

A signature stamp may be added to the transaction-specific form. A template may be inserted as one or more additional pages into form. A combination save option may be selected that also prints the form, uploads a new copy of the same form, reloads the form for continued editing, attaches the forms to an email, or sets a status of the form, or combinations thereof.

A method of generating a library of electronic forms is also provided for documenting business transactions. An existing paper form is scanned, or an externally-residing existing electronic form is imported, as a new form in an electronic system. The new form is customized including adding one or more editable hotspots to the new form. The new form is stored and indexed within the system such that it is accessible to authorized users of the system. The new form is loadable as a transaction-specific form to be displayed on a portable processor-based device, and edited at any hotspot or elsewhere on the form or both, and then stored into the system.

The method further includes the following in various embodiments. The customizing of the form may include configuring a hotspot for adding to the new form and/or adding a preconfigured hotspot to the form. Any of the components of the method of documenting a business transaction may be combined with the method of generating a library of forms as a method that advantageously combines the generating of generic forms and the editing of those forms specific to a business transaction.

In a preferred embodiment, a form may be a patient chart for use in a physician's office, although the methods are applicable to many other professions such as contracting, accounting, legal, engineering or science, among others.

A portable processor-based device is also provided that includes a processor and a display, and a stylus, mouse or keypad, or combinations thereof, for editing a form loaded from a generated library of forms for documenting a business transaction. The device also includes one or more digital storage media having instructions embedded therein for programming the processor to perform any of the methods of documenting a business transaction, or generating a library of forms, as recited herein.

Moreover, one or more digital storage media are also provided having instructions embedded therein for programming one or more processors to perform a method of documenting a business transaction, or generating a library of forms, as recited herein.

### BRIEF DESCRIPTION OF THE DRAWINGS

FIG. 1 illustrates a login screen in accordance with a preferred embodiment, whereby access to the system may be limited only to authorized users.

FIG. 2 illustrates a patient, client or customer list in accordance with a preferred embodiment that is arranged in the form of a day appointment calendar including links to electronic documents relating to listed persons.

FIG. 3 illustrates a message or email inbox of a system in accordance with a preferred embodiment.

FIG. 4 illustrates a message or email in accordance with a preferred embodiment including text and handwritten communications and having an attachment that includes lab results.

FIG. 5 illustrates an electronic patient chart in accordance with a preferred embodiment.

FIG. 6 illustrates a patient demographics portion of the patient chart of FIG. 5.

FIG. 7 illustrates a menu that appears when a link of “office links” is executed at the patient demographics section of the patient chart of FIG. 5.

FIG. 8 illustrates a menu that appears when a link of “clinical staff links” is executed at the patient demographics section of the patient chart of FIG. 5.

FIG. 9 illustrates a patient vitals window of the patient chart of FIG. 5.

FIG. 10 illustrates an appointment summary section of the patient chart of FIG. 5.

FIG. 11 illustrates chart flags in accordance with the patient chart of FIG. 5.

FIG. 12 illustrates symbol names and indications for the chart flags of FIG. 11.

FIG. 13 illustrates a report tabs section of the patient chart of FIG. 5.

FIG. 14 illustrates provider action links of the patient chart of FIG. 5.

FIG. 15 illustrates a listing of active encounter documents that may be viewed and/or edited by executing corresponding links within the patient chart of FIG. 5.

FIG. 16 illustrates an existing paper form that can be scanned into a system in accordance with a preferred embodiment and used as an editable electronic document.

FIG. 17 illustrates a user interface for scanning a paper document into an electronic system in accordance with a preferred embodiment.

FIG. 18 illustrates a paper document being scanned into an electronic system in accordance with a preferred embodiment.

FIG. 19 illustrates the user interface of FIG. 17 with a menu list open for creating, uploading, deleting or resetting a batch, or viewing a document.

FIG. 20 illustrates an indexed list of new forms added to a system in accordance with a preferred embodiment.

FIGS. 21-23 illustrates user interfaces for converting a file into a TIFF image.

FIGS. 24-28 illustrate user interfaces for uploading a TIFF image to an electronic system in accordance with a preferred embodiment.

FIGS. 29-31 illustrates user interfaces for combining multiple image files into one multiple page document.

FIG. 32 illustrates a user interface for indexing a newly uploaded document as form template in an electronic system in accordance with a preferred embodiment.

FIGS. 33-34 illustrate a user interface for managing form templates in an electronic system in accordance with a preferred embodiment.

FIG. 35 illustrates a user interface for setting a template filter and creating rules in an electronic system in accordance with a preferred embodiment.

FIG. 36 illustrates a screen highlight hotspot of an electronic form in accordance with a preferred embodiment.

FIG. 37 illustrates a text highlight hotspot and a hotspot with a favorites pop-up menu of an electronic form in accordance with a preferred embodiment.

FIG. 38 illustrates a tick hotspot of an electronic form in accordance with a preferred embodiment.

FIG. 39 illustrates a link icon hotspot of an electronic form in accordance with a preferred embodiment.

FIG. 40 illustrates an image hotspot of an electronic form in accordance with a preferred embodiment.

FIG. 41 illustrates an audio hotspot of an electronic form in accordance with a preferred embodiment.

FIG. 42 illustrates discretely saving data captured at hotspots into a database of an electronic system in accordance with a preferred embodiment.

FIG. 43 illustrates configuring default values for hotspots of an electronic form in accordance with a preferred embodiment.

FIG. 44 illustrates an autoburn hotspot of an electronic form in accordance with a preferred embodiment.

FIG. 45 illustrates use of a tablet pc for editing an electronic version of a paper form within an electronic system in accordance with a preferred embodiment.

FIGS. 46-50 illustrate user interfaces for generating a transaction-specific form from one or more templates within an electronic system in accordance with a preferred embodiment.

FIG. 51 illustrates a patient encounter form or transaction-specific form that has been edited within an electronic system in accordance with a preferred embodiment.

FIG. 52 illustrates executable icons, along with names and descriptions, of the form of FIG. 51.

FIG. 53 illustrates a document note, a text hotspot and a personal hotspot for editing the form of FIG. 51.

FIG. 54 illustrates check mark, x mark and signature stamps for editing the form of FIG. 51.

FIG. 55 illustrates a user interface for inserting an image into the form of FIG. 51.

FIG. 56 illustrates a user interface for configuring a link hotspot into the form of FIG. 51.

FIGS. 57-58 illustrate a user interface for inserting a template into the form of FIG. 51 and adding it as a last page.

FIG. 59 illustrates icons corresponding to combination save options that may be used when editing the form of FIG. 51.

FIG. 60 illustrates the form of FIG. 51 as a saved image within an electronic system in accordance with a preferred embodiment.

FIG. 61 illustrates how data is captured from the form of FIG. 51 and stored to a database in accordance with a preferred embodiment.

FIGS. 62 and 63 illustrate image and audio capture, respectively, in accordance with a preferred embodiment.

FIG. 64 illustrates data values associated with the form of FIG. 51 being stored to a database of an electronic system in accordance with a preferred embodiment.

FIGS. 65 and 66 respectively illustrates a blank encounter note and an encounter note automatically filled in with information entered at the form of FIG. 51 and stored to a database of an electronic system in accordance with a preferred embodiment.

FIG. 67 illustrates a document generated using in-part information entered at the form of FIG. 51 and stored to a database of an electronic system in accordance with a preferred embodiment.

FIG. 68 illustrates a user interface for reviewing documents within an electronic system in accordance with a preferred embodiment.

FIG. 69 illustrates editing a transaction-specific form, that has been stored earlier following a transaction or patient encounter, in review mode by retrieving it to a display of an electronic system in accordance with a preferred embodiment.

### DETAILED DESCRIPTION OF THE PREFERRED EMBODIMENTS

In places hereinbelow, there are references to workflow.com and workflow application. These are references to a preferred embodiment that happens to be provided by workflow.com LLC (see www.workflow.com, which is hereby incorporated by reference). There are also references herein to “HyperForms™ technology which also refers to a preferred embodiment. Many alternative embodiments are discussed or otherwise understood by those skilled in the art, and available in accordance with the invention. In addition, references are made below to medical applications, although the invention is not so limited, and is instead applicable to other fields of business such as engineering, science, law, accounting, brokerages, real estate, plumbing and heating, contracting generally, electricians, repairs and sales, automobiles, and business practices wherein it is desired that a professional be able to move from place to place while documenting a business transaction.

### Login

A Login screen allows access to a workflow application. Login preferably occurs in one of two ways: the standard method and the Login Assistant. The standard login method reaches Workflow via the Internet, while the Login Assistant reaches Workflow through a desktop icon.

To access the standard login page, a user opens the Microsoft® Internet Explorer® web browser window. In the address bar, the user types the address given by support staff. The user is directed to the login page.

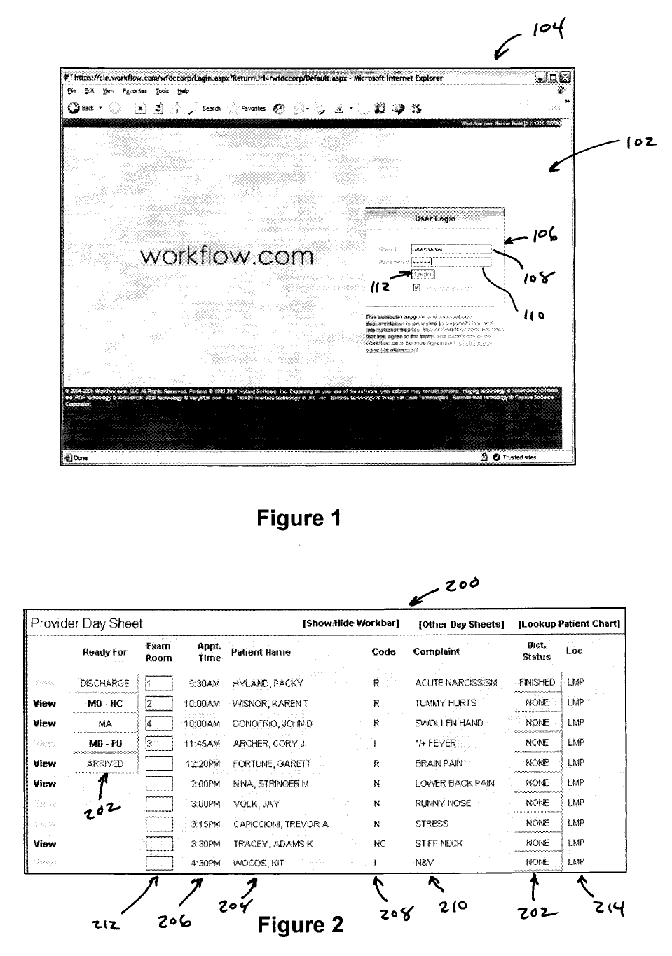

FIG. 1 illustrates a login screen 102 within a browser window 104 in accordance with a preferred embodiment, whereby access to the system may be limited only to authorized users. A user's first encounter with Workflow.com, which is a website configured in accordance with a preferred embodiment, is typically the login screen 102. In order to access the system, the user enters a username and password within a login box 106. Authentication is preferably automatically performed by a computer as provided by an administrator. Passwords are preferably case-sensitive, so “myPASswoRD” is different from “mypassword.”

In the Workflow.com Login screen 102, a user enters a user ID in the field 108 of the exemplary login box 106 of FIG. 1. A user may be prompted to enter a password in the field 110, and to click “Login” 112.

### Patient List (Day Sheet)/Customer List/Calendar

When a user logs in as a Provider (MD, DDS, JD, pharmacist, etc.), the user sees a Day Sheet, allowing viewing of appointments for a day. Day Sheets are displayed preferably based on the following information: appointment date, provider and location.

FIG. 2 illustrates a provider day sheet 200, or patient, client or customer list, in accordance with a preferred embodiment that is arranged in the form of a day appointment calendar including links 202 to electronic documents relating to listed persons. For appointments, the patient's name 204, appointment time 206, encounter code 208, specific complaint 210, status of the visit 202 (e.g., arrived, discharged, finished, in progress, awaiting lab results, etc.), exam room number 212 or other location 214, and/or doctor or nurse involved or other information, are displayed, and links to further details may be provided here. This interface can be customized to meet the needs of particular customers.

### Messaging

Internal messaging provides an organization a means for secure communication related to patient care. Messages may be stored within a patient chart and/or within a day sheet or link therein, and can be accessed while logged into the Workflow site. Messages can be sent, forwarded, replied to, edited and archived.

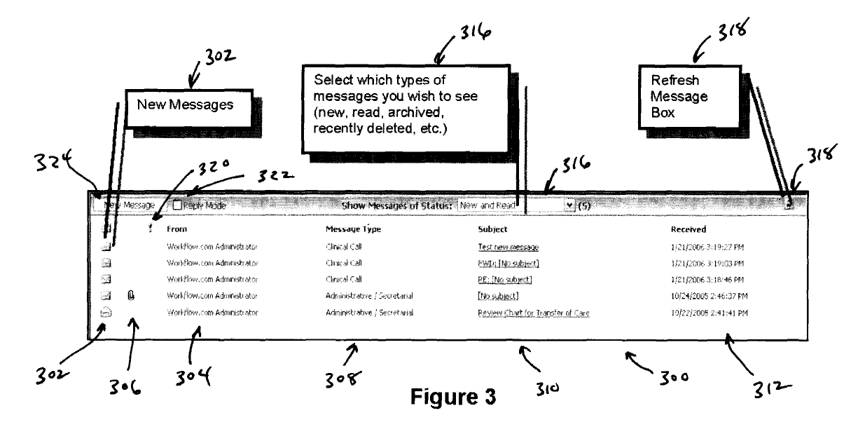

FIG. 3 illustrates a message or email inbox 300 of a system in accordance with a preferred embodiment. The inbox 300 shown indicates new messages 302, whom the message is from 304, whether there is an attachment 306, message type 308, subject 310, and date and/or time of receipt 312. Other information may be provided. The user can select which types of messages to be displayed using menu 316. For example, box 316 indicates that the user has selected to display new and read messages. The user might instead select only new or only read or sent or old or deleted, or archived, or otherwise. The user may also refresh the listing by clicking refresh icon 318. A priority 320 of a message may be indicated, and a user may wish to have the inbox 300 formatted in a reply mode by clicking or tapping in box 322. A user can see that a message that he or she has received is a new message or read message or otherwise by highlighting the message and viewing box 324.

A user may prepare his or her own message to send. For preparing a new message to send, a user may select one or more individual or group recipient(s), indicate a subject, attach a document, select a message type and level of priority. Examples of message types are shown in FIG. 3 at column 308 including clinical call and administrative/sectretarial. Messages may also be personal, recreational, financial, professional, or otherwise.

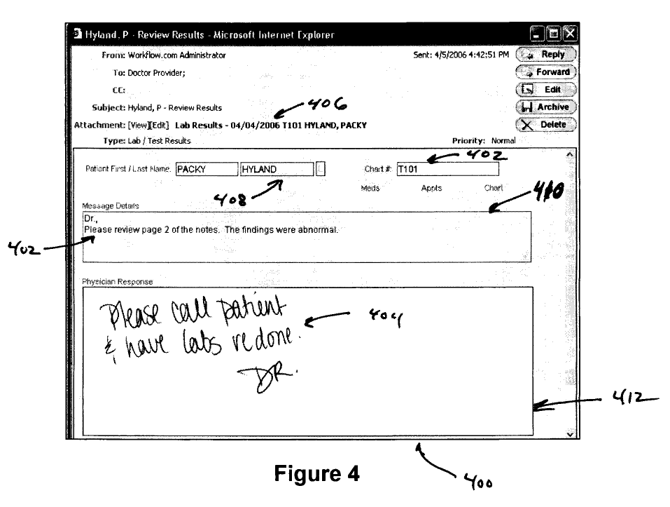

With embedded “E-Form Ink Controls” (a component of HyperForms™ technology), users can type or write within a message using a Tablet PC and stylus. FIG. 4 illustrates a message or email communication window 400 in accordance with a preferred embodiment including text 402 and handwriting 404, and having an attachment 406 that includes lab results. Moreover, the patient's name has been selected from a listing of patients. Note that both an original message box 410 and a response box 412 are provided within window 400.

### Patient Chart

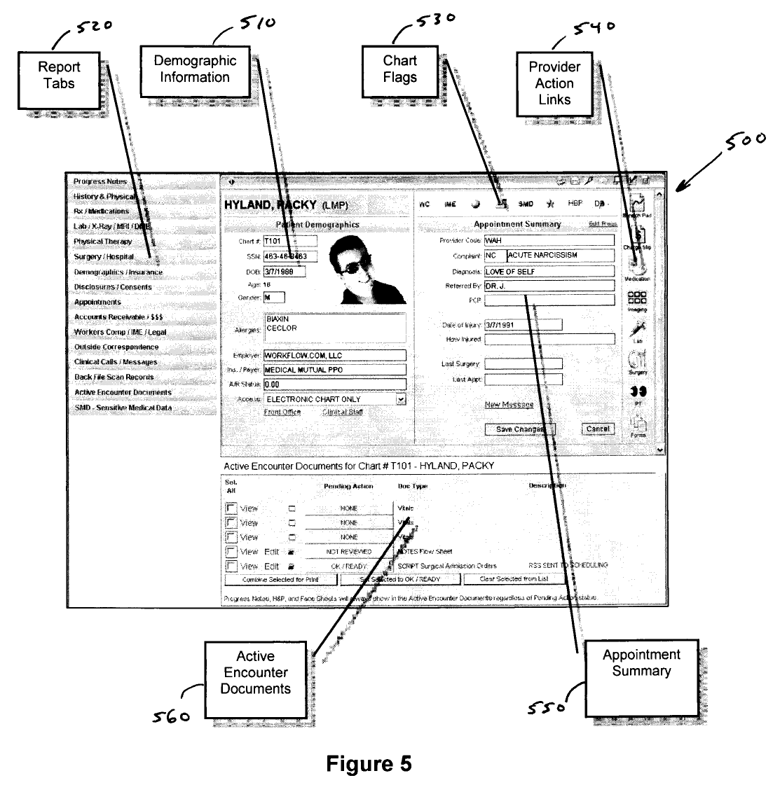

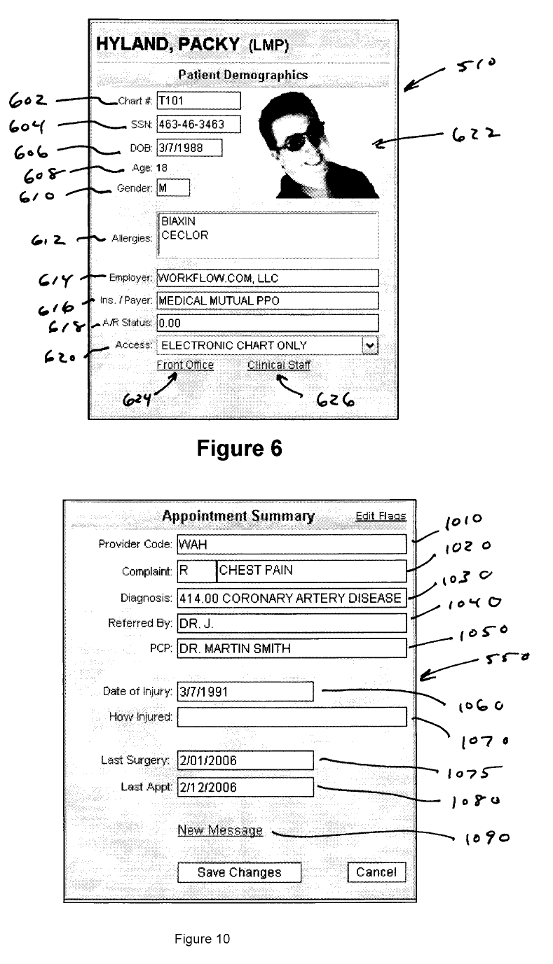

FIG. 5 illustrates an electronic patient chart 500 in accordance with a preferred embodiment. The patient chart of FIG. 5 contains patient information and is preferably broken down into six sections: Patient Demographics 510, Report Tabs 520, Chart Flags 530, Action Buttons 540, Appointment Summary 550 and Active Encounter Documents 560. Depending on user configuration and permissions, a user may or may not see all of these components contemporaneously. For ease of illustration, different components of the patient chart of FIG. 5 are shown in FIGS. 6-15.

### Patient Demographics

FIG. 6 illustrates a patient demographics portion 510 of the patient chart 500 of FIG. 5. The patient demographics section 510 provides general information about the patient such as identifying information and/or medical information. FIG. 6 illustrates boxes that may be filled in with text or writing, or based on a selection from a menu, or in a particularly advantageous embodiment called from a database location linked to the patient. FIG. 6 shows a chart number 602, social security number or SSN 604, data of birth DOB 606, age 608, gender 610, allergies 612, employer 614, insurance/payer 616, accounts receivable or A/R status 618 and access level 620. The patient's picture 622 or other photograph that preferably identifies the patient may also be displayed. There are also a Front Office link 624 and a Clinical Staff link 626.

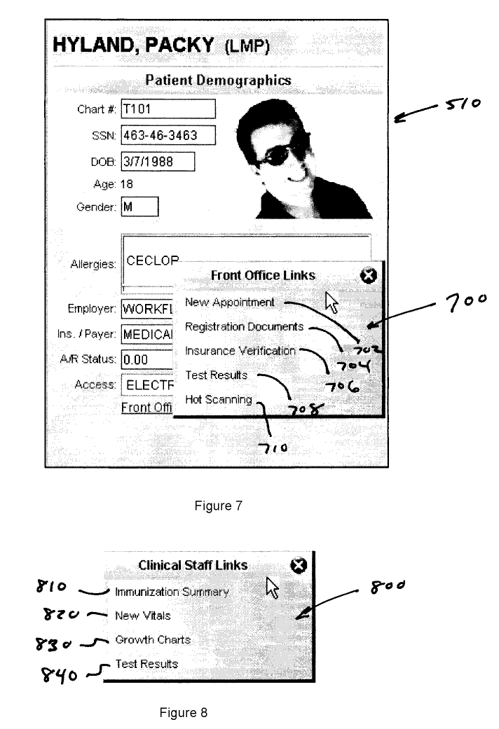

FIG. 7 illustrates a pop-up window 700 that appears when the front office link 624 of the demographics portion 510 of the patient chart 500 is executed. Pop-up window 700 includes the following links: New Appointment 702, Registration Documents 704, insurance verification 706, test results 708, and Hot Scanning 710. The new appointment link 702 permits the scheduling of a new appointment. The registration documents link 704 is a link wherein registration or check-in documents are located, which are documents that are required for patient check in. Hot scanning allows a user to scan documents directly into a patient chart. In this way, information that used to be available only a the front office, are now available by executing link 624 from within a patient chart 500 in accordance with a preferred embodiment. Other documents may be uploaded for access through a patient chart 500. For example, insurance verification 706 or test results 708 may be checked by a mouse click or stylus tap within a demographics portion 510 of a patient chart 500.

### Clinical Staff

The Clinical Staff link 626 is also customizable. FIG. 8 illustrates a menu 800 that appears when the clinical staff link 626 is executed at the patient demographics section 510 of the patient chart 500 of FIG. 5. Links to an immunization summary 810, new vitals 820, growth charts 830 and test results 840 are available within the illustrative pop-up window 800. In this way, information that used to be available only at the lab or on copies of lab results being held at the front office or otherwise remotely from the physician's easy access, are now advantageously readily available by executing link 626 from within a patient chart 500 in accordance with a preferred embodiment.

FIG. 9 illustrates a patient vitals window 900 that may appear upon execution of the vitals link 820 of FIG. 8 and/or directly from a link at the main patient chart window 500 of FIG. 5. The Patient Vitals window 900 allows a user to enter and view patient vital information 910 such as height, weight, head circumference, BMI, BSA, heart rate, respiratory rate, temperature, SPO2 and systolic and diastolic blood pressure. Patient demographic information 920 may also be entered or called from one or more database entries associated with the patient, or from an already prepared demographics window 510, including entries 602, 604, 606, etc. of FIG. 6. The date and time 930 that the vitals were taken is also shown within window 900 of FIG. 9.

### Appointment Summary

FIG. 10 illustrates an appointment summary section 550 of the patient chart 500 of FIG. 5. The appointment summary section 550 contains information about a patient's most recent visit. Appointment summaries may also be stored from previous visits, and may also be available from within the section 550, e.g., by executing a link, or may be available within a separate archive or link accessible from the patient chart 500. The appointment summary section 550 includes boxes for entry of text or handwritten information, or information that may be called from a database. Section 550 of Figure includes provider code 1010, complaint 1020, diagnosis 1030, referral source 1040, primary care physician PCP 1050, date of injury 1060, explanation of how the injury occurred 1070, last surgery date, anesthetic or other information 1080, and a link to the messages window 300 and email communications interface of FIG. 3.

### Chart Flags

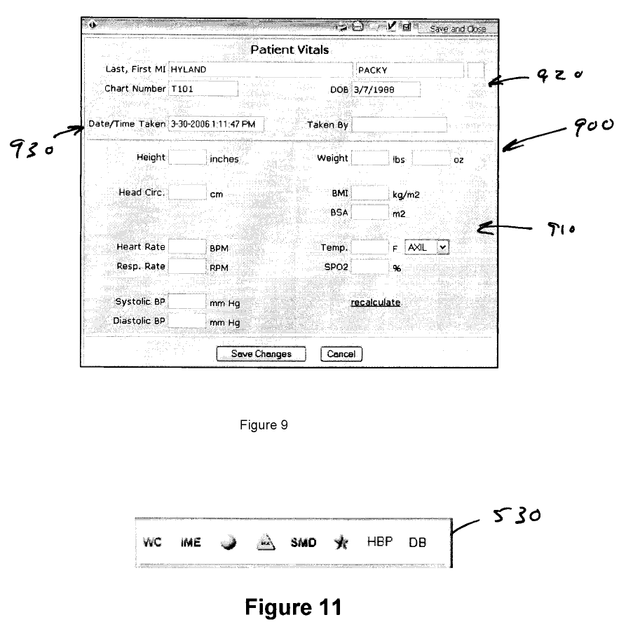

FIG. 11 illustrates chart flags 530 in accordance with the patient chart 500 of FIG. 5. Chart flags 530 are preferably located above the appointment summary 550 of the chart 500 of FIG. 5. Chart flags 530 help quickly identify important patient information. When a symbol or identifier among one or more or preferably several symbols available within the chart flags section 530 is applicable to the patient, the icon is preferably in color or otherwise highlighted with background color, raised or bolded type or otherwise. When a symbol or identifier is not applicable to the patient, the icon is preferably grayed out.

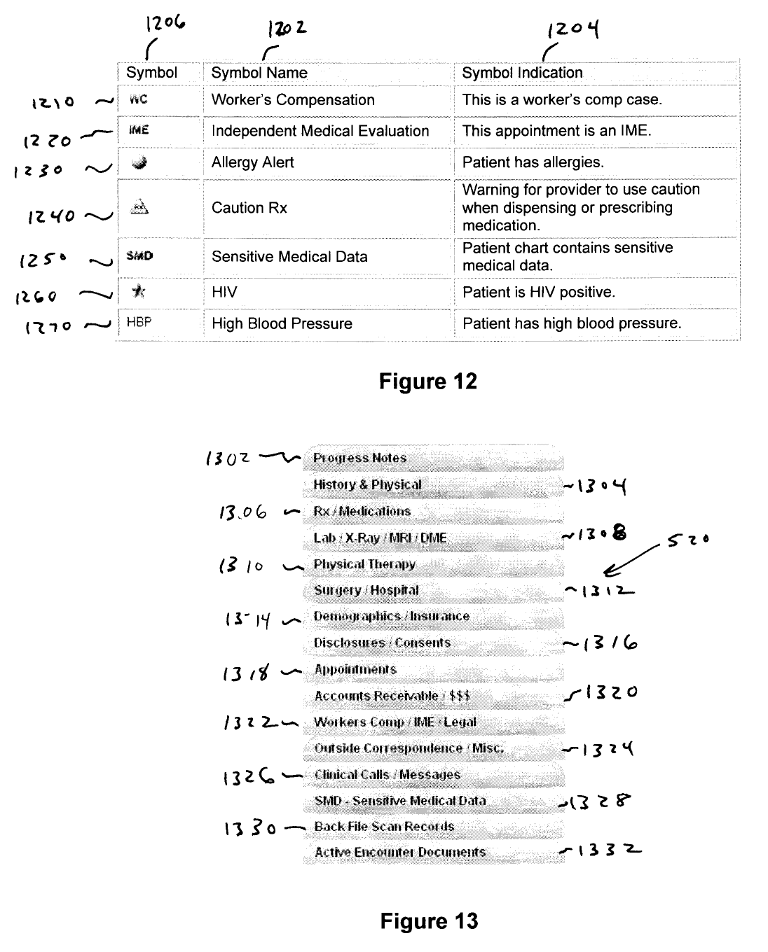

FIG. 12 illustrates indicator or symbol names 1202 and indications 1204 for each of the symbols 1206 of the chart flags section 530 of FIGS. 5 and 11. If the workmen's comp symbol 1210 is executed from the patient chart 500, a user can see whether the case is a worker's comp case or not. If the independent medical evaluation or IME symbol 1220 is executed from the patient chart 500, then a user can see whether the appointment is a IME or not. If the allergy alert symbol 1230 is executed, a user can see whether the patient has allergies. If the caution Rx symbol 1240 is executed, a user can see whether a provider is warned to use caution when dispensing or prescribing medication. If the sensitive medical data symbol 1250 is executed, the user can see whether a patient chart contains sensitive medical data. If the HIV symbol 1260 is executed, the user can see whether the patient is HIV positive or negative. If the high blood pressure symbol 1270 is executed, the user can see whether the patient has high blood pressure. Other information may be available such as circumstances behind a warning, or the sensitive nature of the data, or particular allergies, or the measured blood pressure of a patient.

### Reports Tabs

FIG. 13 illustrates a report tabs section 520 of the patient chart 500 of FIG. 5. Report tabs 520 organize patient-related documents, including documents created within the software, outside scanned documents, and/or documents that existed within the patient's paper chart. After a tab is clicked, its contents are preferably provided below the patient chart 500 on a display screen. To open the documents then listed within the tab, the respective document link can be executed, e.g., clicked on with a mouse or tapped on with a stylus. Examples of tabs within the report tabs section 520 include progress notes 1302, history and physical 1304, Rx/medications 1306, Lab, X-ray, MRI, DME 1308, physical therapy 1310, surgery/hospital 1312, demographics/insurance 1314, disclosures/consents 1316, appointments 1318, accounts receivable 1320, worker's comp/IME/legal 1322, outside correspondence/misc. 1324, clinical calls/messages 1326, SMD or sensitive medical data 1328, back file scan records 1330 and/or active encounter documents 1332.

### Provider Action Links

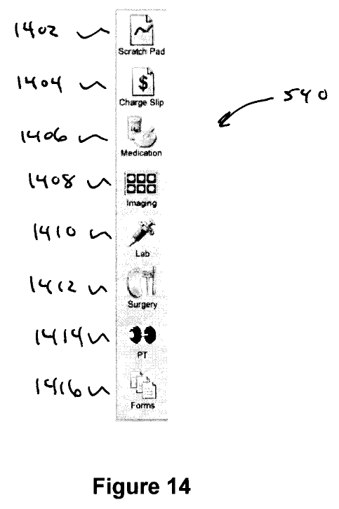

FIG. 14 illustrates provider action links 540 of the patient chart 500 of FIG. 5. The provider action links 540 are preferably located to the right of the appointment summary 550 in the chart 500, and allow users to create new documents using HyperForms™. There are illustrative icons shown in FIGS. 5 and 14 for a scratch pad 1402, a charge slip 1404, medication 1406, imaging 1408, lab 1410, surgery 1412, physical therapy or PT 1414 and/or forms 1416.

### Active Encounter Documents for Charts

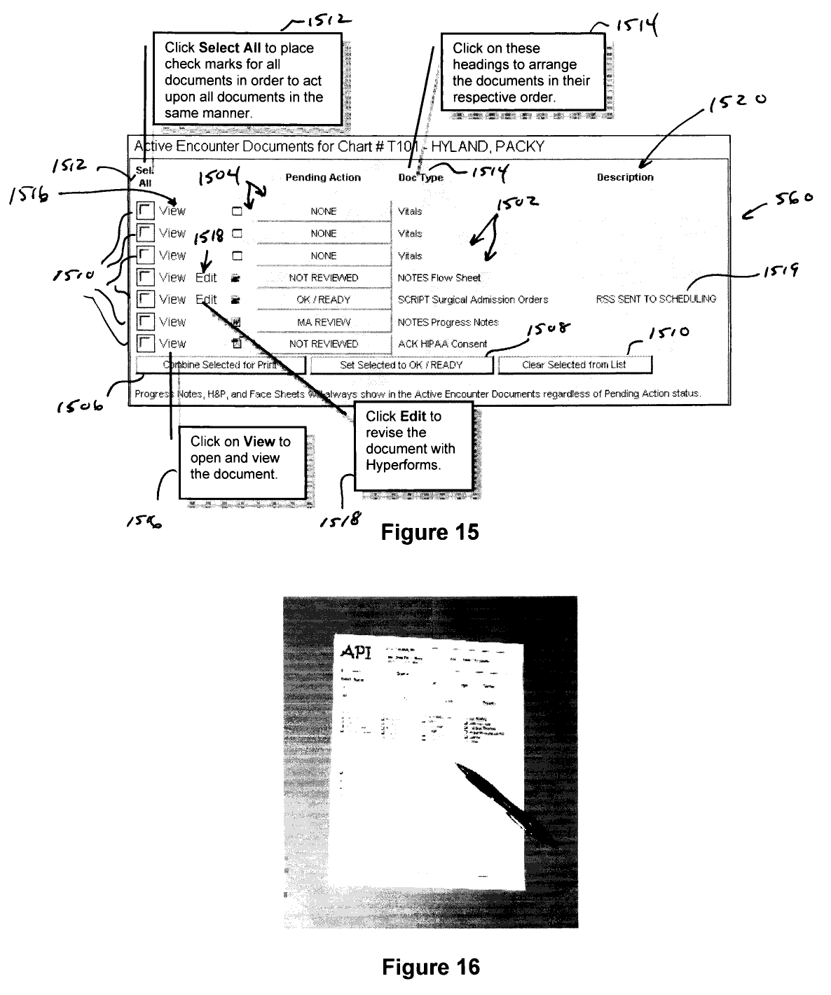

FIG. 15 illustrates an active encounter portion 560 of a patient chart 500, and includes a listing 1502 of active encounter documents that may be viewed and/or edited by executing corresponding links 1504. This portion of the patient chart 500 shows a list of documents awaiting review by the MA, doctor or other staff member. The active encounter documents are accessed by clicking on any of the report tabs 1302-1332 of the report tabs section 520 of the patient chart 500. Active documents for a particular one of the report tabs 1302-1332 are then listed in the Active Encounter window 560. The buttons labeled Combine Selected for Print 1506, Set Selected to OK / READY 1508, and Clear Selected from List 1510, are options that allow a user to act upon selected active encounter documents. A user may select one or more of the documents by clicking the corresponding box 1510 or click select all 1512. Documents may be arranged in a particular order depending on sort criteria selected 1514. Documents may be viewed by clicking a view icon 1516, or edited by clicking an edit icon 1518. A description 1519 or other comment 1519 may be inserted in a description column 1520.

### Template Import and Administration

In an advantageous embodiment, an organization can take paper forms that have been and/or may be currently used, and import them into the WorkflowEHR solution for use in HyperForms. That is, an existing paper document can be scanned and used as an electronic form without changing its content or appearance. Such paper forms may be converted to digital images, imported into the Workflow.com solution, configured for use by an authorized user, and then put into production and ready for use as a powerful replacement of the former paper form.

Paper forms can be converted to digital image (TIFF or JPEG) by scanning the paper document—or by converting other electronic file formats such as Microsoft Word, Excel or Publisher; PDF; or Pagemaker directly into digital images (TIFF or JPEG). That is, existing externally-residing electronic forms may also be imported into the system, in addition to scanned papers forms.

### Forms Exists as Paper Document

An original form that will be brought into a system in accordance with a preferred embodiment, may exist as a paper document as illustrated at FIG. 16. An existing paper is shown in FIG. 16 that can be scanned into a system in accordance with a preferred embodiment and used as an editable electronic document.

### Scanning a Form to Convert it to a Digital Image

A paper form can also be scanned and uploaded into the Workflow.com software via Document Scanning. Document Scanning allows users to scan a physical piece of paper and create an image from that paper document. This software application automatically communicates with Workflow servers and uploads an electronic file to the Workflow.com web solution.

### How to Use Document Scanning

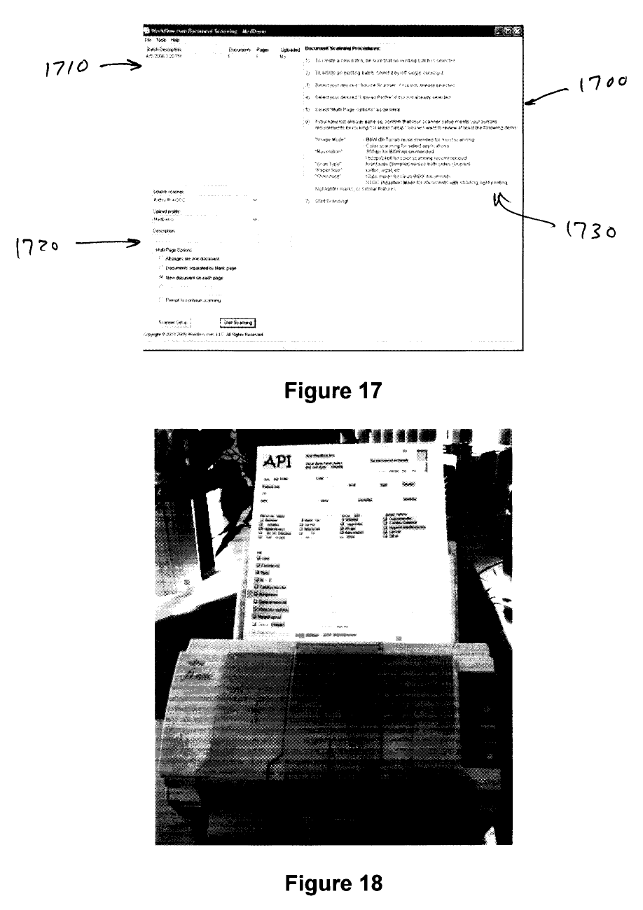

FIG. 17 illustrates a user interface 1700 for scanning a paper document into an electronic system in accordance with a preferred embodiment. The user interface 1700 includes a batch/description section 1710, and a details section 1720 wherein it is indicated what type of scanner is to be used, how the scanning is to be performed on a page (e.g., front and back, new document for each page, separation of documents by a blank page in a single scanned document, upload profile, etc.). The interface 1700 also sets forth the document scanning procedures at the right hand side 1730.

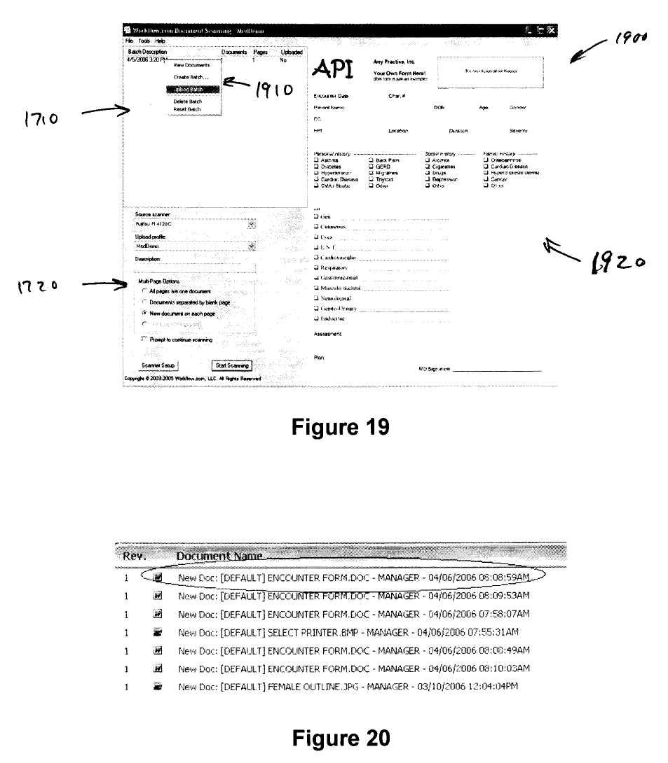

For open document scanning, a paper is to be placed in the scanner, such as illustrated at FIG. 18. Scanner Settings can be altered (one page vs. multi page, back & white vs. color, etc). A user can select “Start Scanning” to scan the form. When scanning is complete, a user can right-click on a batch name and select Upload Batch from a menu list 1910 as shown in FIG. 19. That menu list allows a user to create, upload, delete or reset a batch, or view a document. The interface 1900 of FIG. 19 also shows an electronic version 1920 of the scanned document.

Upon selection of upload batch from the menu list 1910, the file will then enter the system in accordance with a preferred embodiment as a ‘New Un-Indexed Document.’ FIG. 20 illustrates an indexed list of new forms added to a system in accordance with a preferred embodiment. Such new forms may be existing paper forms scanned into the system, and/or may instead or in addition include existing electronic forms that are or were externally-residing from the system and imported therein.

### Converting Electronic Files to Digital Images

The external-residing electronic form can exist in any of a variety of electronic formats (i.e. Microsoft Word, Excel or Publisher; PDF; or Pagemaker). A user can create a digital image (TIFF or JPEG) in several ways.

### Converting a File into a TIFF Image

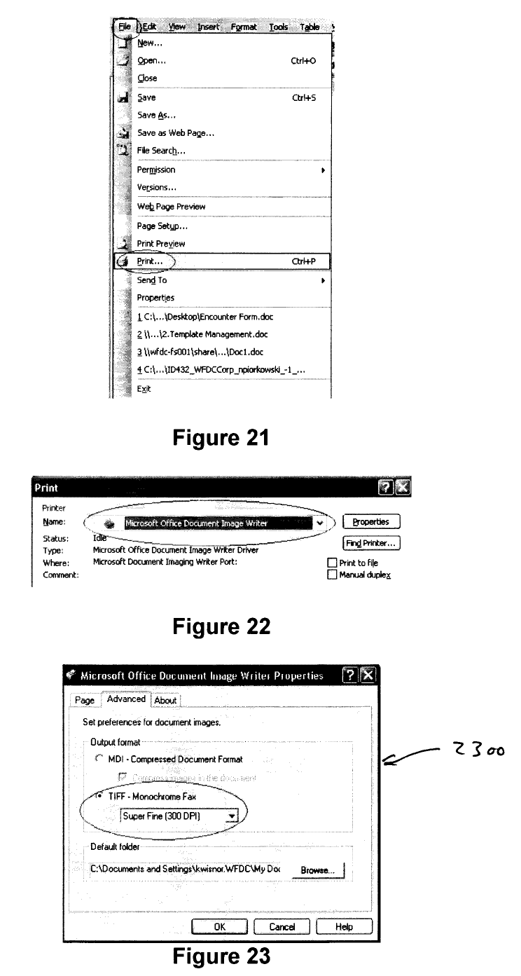

One example of creating such digital image, and also perhaps the easiest way, is to print the document to Microsoft Office Document Image Writer. This creates an electronic TIFF image. FIGS. 21-23 illustrates user interfaces for converting a file into a TIFF image. A “Print” selection is executed as illustrated at FIG. 21, and then a selection of Microsoft Office Document Image Writer among print locations is made as illustrated at FIG. 22. TIFF is selected as illustrated at FIG. 23, wherein the user interface 2300 also offers a MDI compressed document format selection. Thus, from “Properties”, a user should select the Advanced Tab and make sure that the Output format is TIFF. Monochrome Fax at Super Fine DPI (300) can also be selected, and then a user can click OK to close the Properties box, and click OK to print/convert the document into a tiff image.

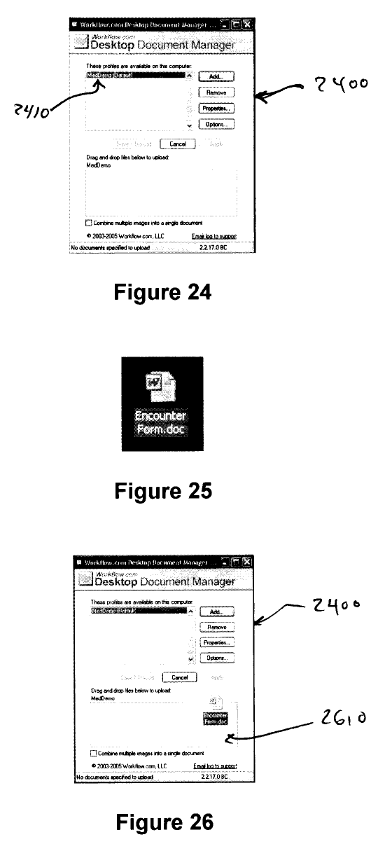

A user can select a location on his or her machine where the document is to be saved. The Form Image can then be imported with Desktop Document Manager. Based on the above procedure, the document now exists as a TIFF image and is ready to be uploaded into the Workflow.com software via the Workflow.com Desktop Document Manager (DDM) 2400 as illustrated at FIG. 24. DDM allows users to drag-n-drop electronic files into a software application that automatically communicates with the Workflow servers and upload the electronic file to the Workflow.com web solution.

FIGS. 24-28 illustrate user interfaces for uploading a TIFF image to an electronic system in accordance with a preferred embodiment. The Desktop Document Manager 2400 is opened by double-clicking a DDM icon. The document, as illustrated by the Word document icon illustrated at FIG. 25, may be uploaded by Drag-n-dropping into the upload region 2610 illustrated at FIG. 26.

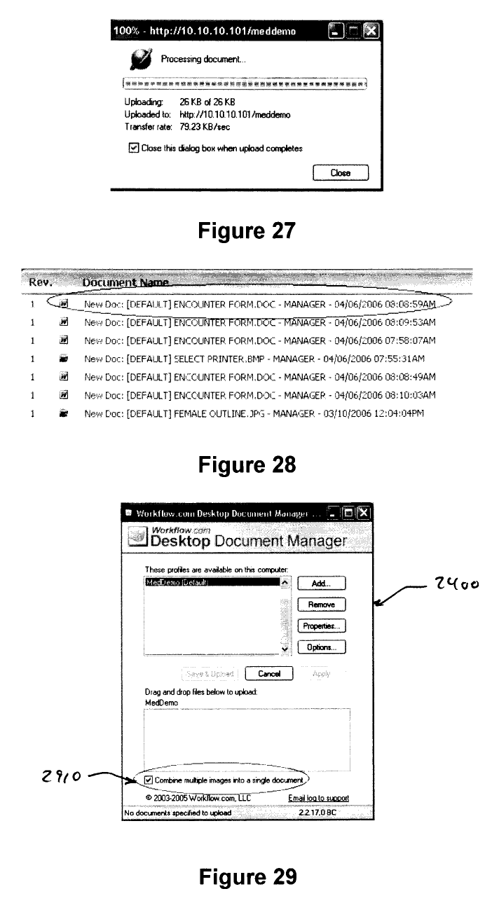

A user may wait for the application to communicate with servers as illustrated at FIG. 27. The file then uploads to the designated Workflow.com site. The file will enter the site as a ‘New Un-Indexed Document’, as illustrated at FIG. 28 Now the electronic file that was created within Word exists as a TIFF image and is stored within the Workflow.com solution.

### Importing Multi-Page Forms with Desktop Document Manager

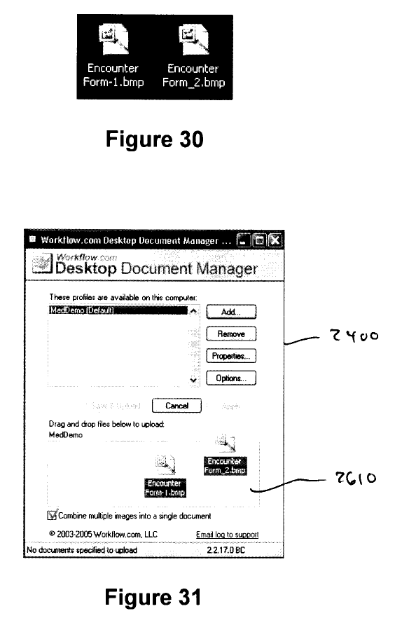

FIGS. 29-31 illustrates user interfaces for combining multiple image files into one multiple page document. The Workflow.com Desktop Document Manager interface 2400 also provides for combining two or more individual TIFF or JPEG image files into one multiple page document by clicking or checking element 2910, where it says ‘Combine Multiple Images Into a Single Document.’ FIG. 30 illustrates the selecting of two (or more) TIFF image files. FIG. 31 illustrates drag-n-dropping of the files into Desktop Document Manager box 2610. The files are then uploaded to the server and combined into a multiple page document.

### Index the Newly Uploaded Document as Form Template

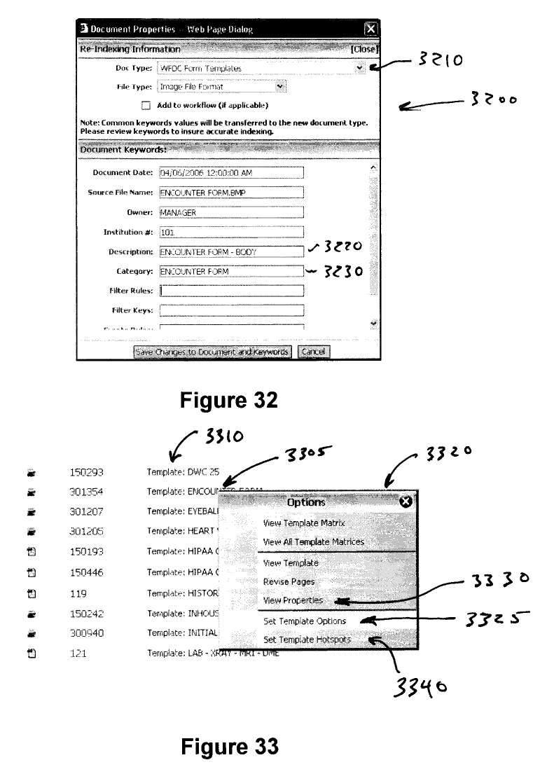

FIG. 32 illustrates a user interface 3200 for indexing a newly uploaded document as form template in an electronic system in accordance with a preferred embodiment. A user may right-click on a document name, and select “re-index the doc”. The user may then assign the document a new document type (WFDC Form templates) 3210, as illustrated at FIG. 32. The user can then enter a description, 3220, and category name 3230. The default pending action should then be indicated. Once the document has been uploaded into the Workflow.com software, it exists as a New Un-Indexed Document. Each document within the software can have multiple templates associated with that document type. A new document type is now assigned to this document and properties are assigned for this specific template. These attributes can be assigned through Workflow.com Document Retrieval.

### Retrieving the Form Template & Settings Template Options

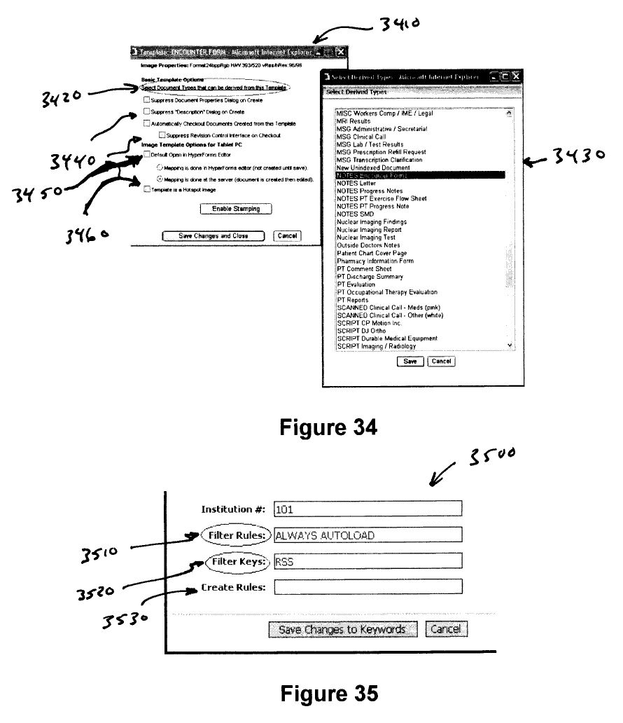

FIGS. 33-34 illustrate a user interface for managing form templates in an electronic system in accordance with a preferred embodiment. Workflow.com is configured for preferably storing all templates for each document type within the Manage Forms Template Library. In this Library, a user can manage the properties of the template, such as its document type classification, data mapping values and creation details.

A user can first find a template name 3305 in a list 3310, and right-click to open a menu 3320 and set template options 3325 by clicking and opening a window 3410. By clicking on Select Document Types 3420 within window 3410, a user can select the document type that the template should be applied to within another window 3430. A user can check any of the relevant checkboxes 3440 related, e.g., to suppressing the document or document revisions. A user can also check box 3450 if the template should be opened with HyperForms™ as a primary document, or box 3460 if the document should be used as a Hotspot Image (described further below).

### Set Template Filter Template & Create Rules

There are several ways to manipulate the creation of a template. Filter keys and rules allow for a particular user to see a filtered list of templates. Filter keys store the data that the master list of templates are filtered by. Filter Rules define the resulting list.

A user can create rules that can be defined for a template. This allows for the insertion of a single page template or multiple templates or a section of a template into the document that is created from the initial template. Referring briefly back to FIG. 33, the user can right-click on the document name within the Manage Forms Template Library 3310, to get menu 3320, and then select View Properties 3330. FIG. 35 illustrates a user interface 3500 for setting a template filter and creating rules in an electronic system in accordance with a preferred embodiment. As shown, a user can determine filter rules 3510 and filter keys 3520. In addition, a user may assign “create rules” 3530, as needed or desired. Menu 3320 of FIG. 33 also allows a user to set template hotspots 3340. Further description of template data mapping and hot spot configuration are provided below.

### Configuring Hotspots

HyperForms allows users to create hotspots. There are hotspots that define an area that can highlight a portion of a document; display default data; select a preset region; provide a list of data or image choices to select from; display a link to a web site; open a new document, or insert an image, all while collecting data values.

### Screen Highlight Hotspot

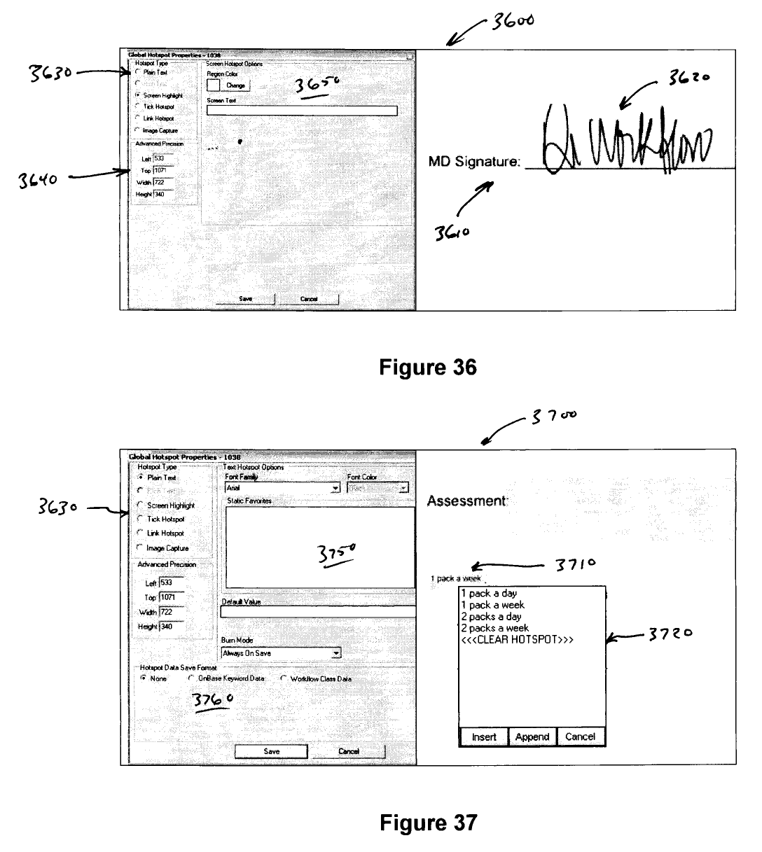

Screen highlight hotspots are similar to using a highlighter in the paper world. FIG. 36 illustrates a screen highlight hotspot of an electronic form in accordance with a preferred embodiment. In the example of FIG. 36, a MD signature line 3610 is provided, whereon a MD can write his or her signature 3620. The area created by a screen highlight hotspot is a light screen where the color can be customizable. A default value can be set within this hotspot, but generally no keyword value is stored to the server. This feature is merely cosmetic in a preferred embodiment, and not intended for data use, although alternatively it may be stored to the database along with other hotspot data.

Another feature of the electronic form 3600 of FIG. 36 is a hotspot type menu 3630. A hotspot type may be selected from the menu such as plain text, rich text, screen hightlight, tick hotspot, link hotspot, image capture and/or any other hotspot type that may be used with the form 3600. An advanced precision box 3640 is also provided. When one of the hotspot types if selected from menu 3630, an options box 3650 provides options specific to the selected hotspot type, e.g., screen hotspot options.

### Plain Text Hotspots

FIG. 37 illustrates a text highlight hotspot 3710, which is also a hotspot 3710 with a favorites pop-up menu 3720 of an electronic form 3700 in accordance with a preferred embodiment. Plain text hotspots 3710 allow insertion of plain text and can save keyword values back to the server. A default value can be entered into this hotspot, and favorites can be used within this hotspot, or the hotspot can remain blank for the user to insert text in. A plain text hotspot that is blue or a randomly selected first color, may be a hotspot without favorites, while a pink hotspot, or a randomly selected different second color, may be a hotspot with favorites. A user could select font, font size, and/or color (on color forms). This hotspot type 3710 can be used in conjunction with embedded handwriting or voice recognition (Microsoft XP TabletPC Edition®, Dragon Medical®, etc.). An text hotspot options box 3750 is also shown in FIG. 37, wherein font family and color, static favorites, default values ande burn mode may be specified. A hotspot data save format box 3760 is also provided, wherein, e.g., none, OnBase Keyword Data and Workflow Class Data can be chosen from.

### Tick Mark Hotspot

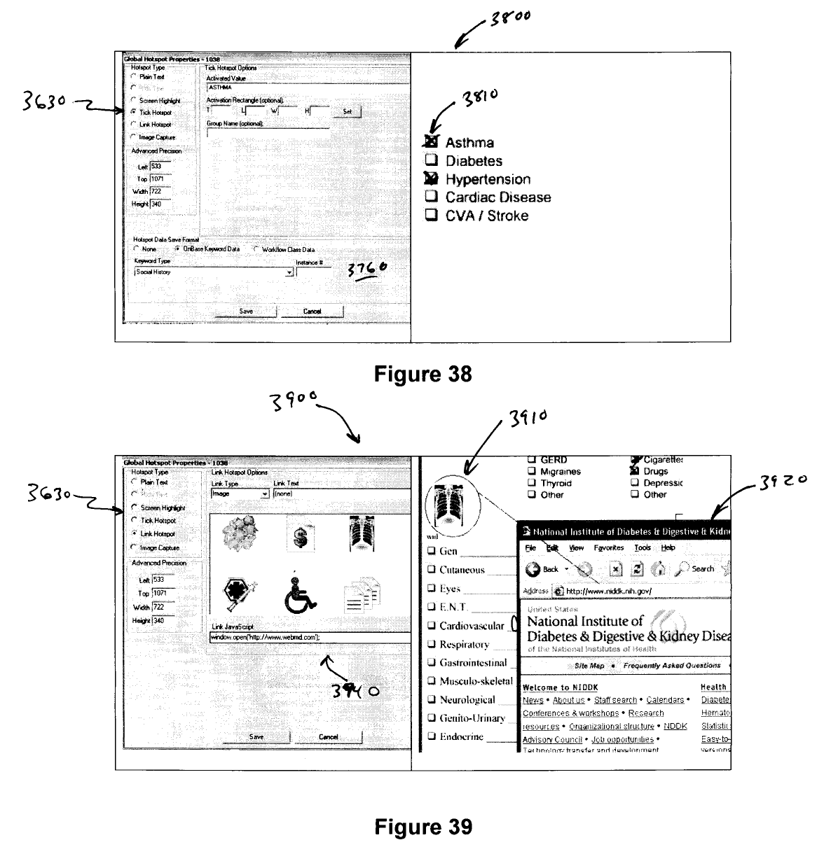

FIG. 38 illustrates tick hotspots 3810 of an electronic form 3800 in accordance with a preferred embodiment. A tick mark hotspot 3810 provides a location in the form 3800 where a user can use a tablet pen and tap in a preset area, point and click or otherwise. This automatically places an “x”, or a check or other predetermined marking, in the hotspot 3810. In a preferred embodiment, associated text is highlighted upon execution of the tick hotspot 3810. A tick hotspot 3810 can be configured so that a value is recorded as a data value in the SQL database for that document 3800.

### Link Icon Hotspot

FIG. 39 illustrates a link icon hotspot 3910 of an electronic form 3900 in accordance with a preferred embodiment. Creating a link icon 3910 renders an image or hyperlink on a Hyperform™ document that acts as a button. By clicking or tapping the button 3910, a pre-configured java script launches a browser window 3920 for opening a URL or opens a new document. The image 3910 can be selected from a link hotspot options box 3940, wherein link type, link text and link JavaScript may also be specified.

### Image Hotspot

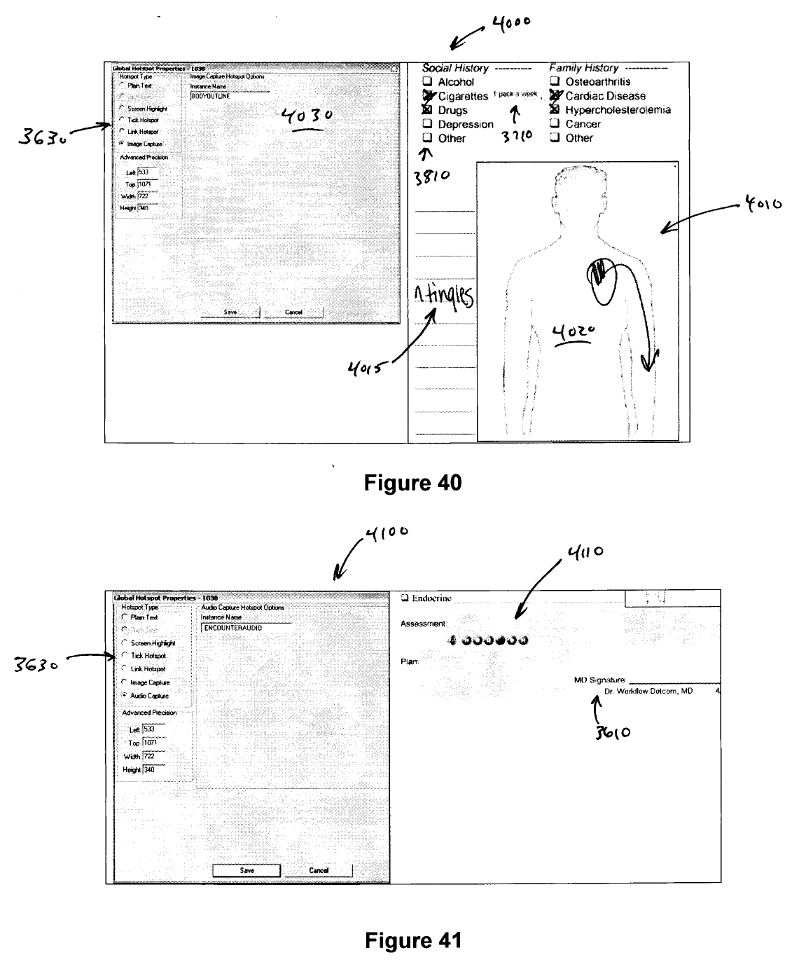

FIG. 40 illustrates an image hotspot 4010 of an electronic form 4000 in accordance with a preferred embodiment. An image hotpot 4010 is a defined area on a form where data 4015 written to that area can be captured and stored in the SQL database and later mapped or imported into other documents and reports. Users can also insert an image 4020 from a Template Library and further annotate it. An instance name can be appended to the image 4020 from an image capture hotspot options box 4030.

### Audio Hotspot

FIG. 41 illustrates an audio hotspot 4110 of an electronic form 4100 in accordance with a preferred embodiment. HyperForms™ can also capture audio data related to a hotspot 4110 as a discrete data instance related to the document. An audio stream can later be played back, edited, embedded in another document, or sent to a queue for computer or human based transcription to text.

### Saving Data Collected with Hotspots

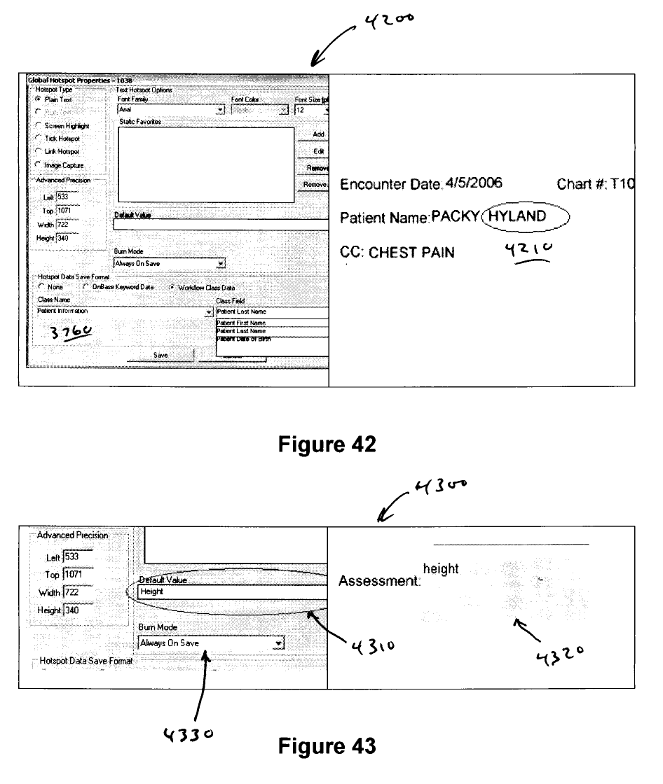

FIG. 42 illustrates discretely saving data captured at hotspots into a database of an electronic system in accordance with a preferred embodiment. Data collected in the hotspots is saved onto the form itself and can also be saved to the SQL database so that captured data can be mapped to new documents, searched and used in various reports, analyzed using various data mining tools, and/or exported to other systems, as desired. For example, a patient named Packy Hyland with chest pain is the subject of the exemplary form 4200 having a text hotspot 4210. Workflow class data is selected from the hotspot data save format box 3760 in FIG. 42. Patient information is selected as a class name, and patient first name is selected a class field in the box 3760. The patient's last name, “Hyland”, as shown in the hotspot 4210, is consequently saved in the database as the last name of the patient who is associated with the form 4200.

### Configuring Default Values for Hotspots

Default values are populated when a new document is created at runtime from a template. FIG. 43 illustrates configuring a default values 4310 for a hotspot 4320 of part of an electronic form 4300 in accordance with a preferred embodiment. FIG. 43 also illustrates a burn mode 4330 that is set to Always On Save.

### Autoburn Hotspots

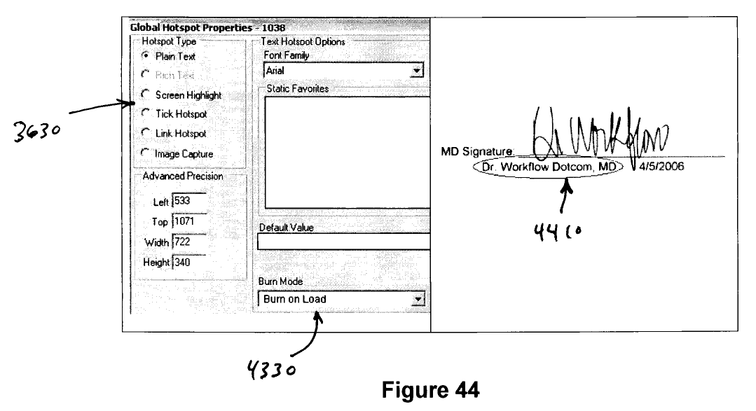

Referring now to FIG. 44, if a hotspot burn mode 4330 is set to ‘Burn on Load’, instead of to Always On Save as in FIG. 43, then HyperForms™ automatically stamps the image 4410 with the contents of the autoburn hotspot 4410 prior to user interaction at runtime. The user never directly sees this hotspot 4410, only the resulting burned value. The burned value can be static, or it can be dynamically determined based on the context in which the document was created. In configuring a text hotspot type, the hotspot can be automatically burned to the image (before user interaction) as in FIG. 44, burned at the save of the document as in FIG. 43, or in a third burn mode, burned on demand leaving the data of the hotspot editable until it is “signed off”.

### Using Templates in a Patient Encounter

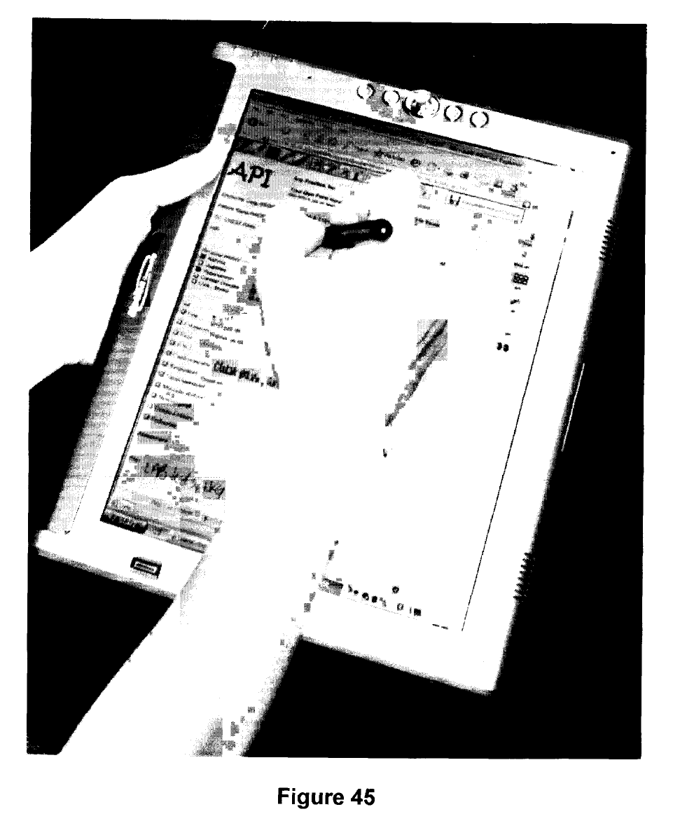

FIG. 45 illustrates use of a tablet pc for editing an electronic version of a paper form within an electronic system in accordance with a preferred embodiment. FIG. 45 illustrates HyperForms in action.

### Template

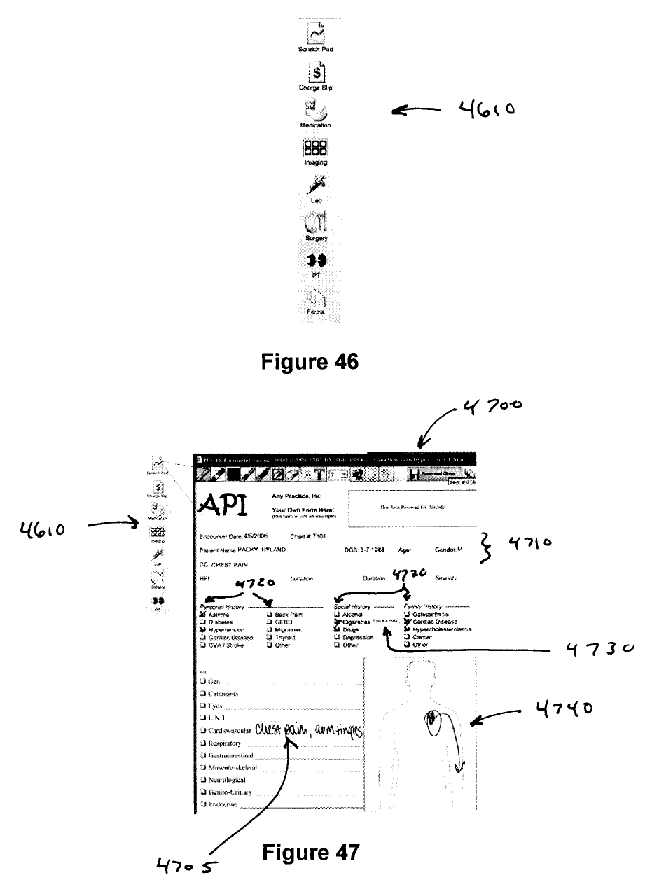

FIGS. 46-50 illustrate user interfaces, user interface screen displays or portions or components of screen displays, for generating a transaction-specific form from one or more templates within an electronic system in accordance with a preferred embodiment. Documents are created by selecting an action link from an action link tool bar 4610, as illustrated at FIG. 46, on the Patient Chart Cover Page which loads a template, as illustrated at FIG. 47, that has been stored within the Workflow solution. Eight examples of action links are provided in FIG. 46, including scratch pad, charge slip, medication, imaging, lab, surgery, PT and forms. Once an action link is clicked, tapped or otherwise executed such as by scrolling and hitting an enter key, the desired document is opened in HyperForms™ Editor enabling the ability to write directly on the electronic document.

The form 4700 illustrated at FIG. 47 includes writing 4705, and some biographical information that may be at one or more autoburn hotspots. There are also tick hotspots 4720, a text highlight hotspot 4730, an image hotspot 4740 Selecting an action link from the Patient Chart Cover Page opens a blank document created from a template.

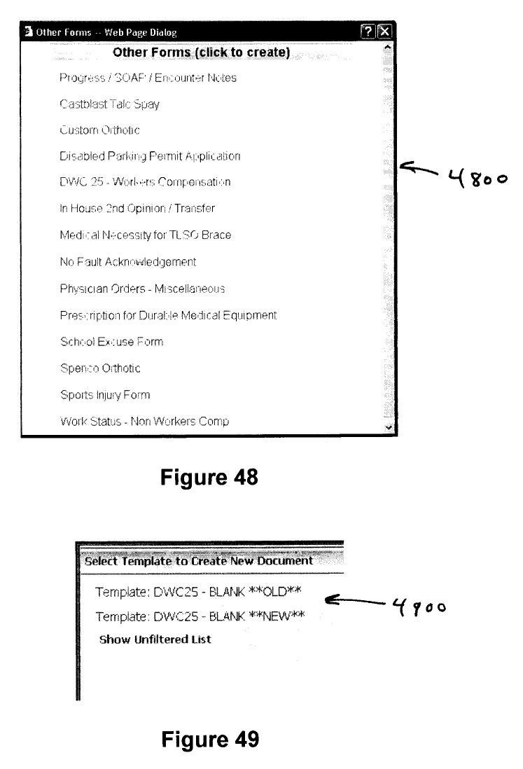

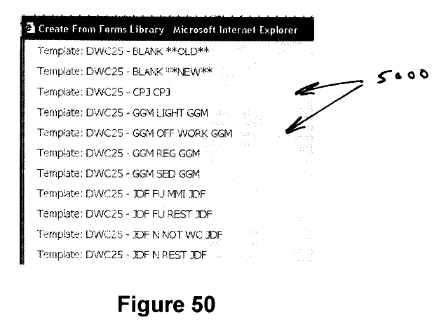

Some Action Links automatically load the template in HyperForms™. Some Action Links also open a window 4800, as illustrated in FIG. 48, which displays a list of other forms available to the organization. Referring to FIGS. 49 and 50, the list of forms 4800 of FIG. 48 can be filtered to display available templates 5000 as well as a list of filtered templates 4900 for a particular user.

A filtered list, as illustrated at FIG. 49, shows a selection of templates based on a Filter Key that can be defined when setting up the template. An unfiltered list, as illustrated at FIG. 50, shows all possible templates for a document type.

### Creating and Editing with Hyperforms

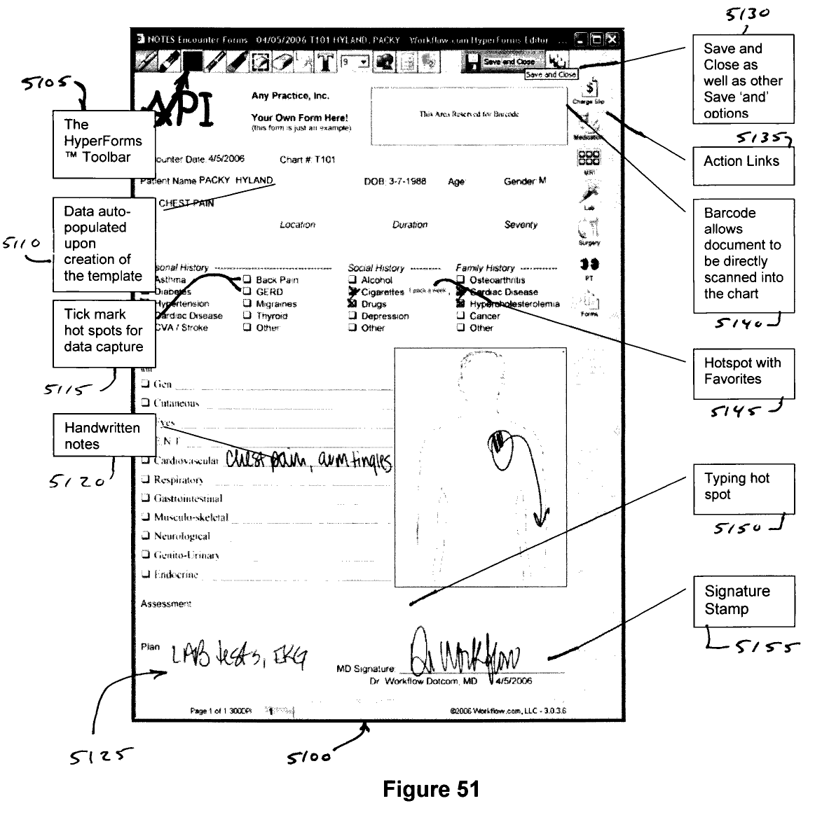

After creating a new document via an Action Link, the document opens in HyperForms™ allowing users the ability to input data into the document in a variety of ways. Users can handwrite, dictate, use tick mark hot spots, type, select favorites from a drop down list and stamp a signature. FIG. 51 illustrates a patient encounter form 5100 or transaction-specific form 5100 that has been edited within an electronic system in accordance with a preferred embodiment. FIG. 51 illustrates many features of an advantageous edited and editable electronic form 5100 including one or more hotspots in accordance with a preferred embodiment.

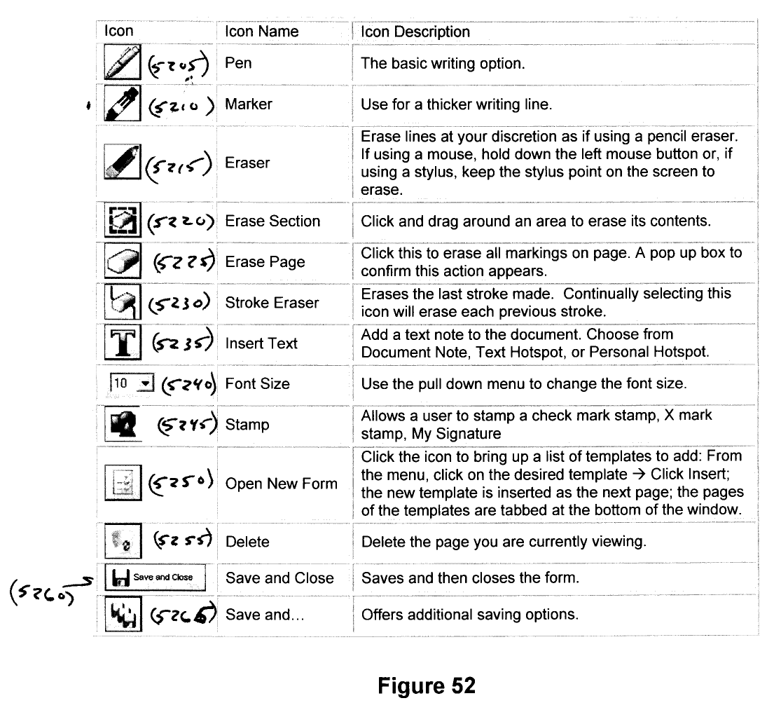

The form 5100 includes a hyperforms toolbar 5105 which will be described in greater detail below with reference to FIG. 52. An autoburn hotspot 5110 is also illustrated, wherein data is auto-populated upon creation of the template for the form 5100. Tick mark hotspots 5115 are shown as earlier illustrated with reference to FIG. 38. Handwritten notes 5120, 5125 are also illustrated. The handwritten notes 5120 have been inserted randomly within the document and will be preferably only stored with the image 5100, while the handwritten notes 5125 have been inserted at a hotspot, such that the latter handwritten notes 5125 will be stored into a database both as hotspot information and with the image 5100.

The form 5100 also includes save and close, as well as other save options 5130. Action links 5135 are as described with reference to FIGS. 46 and 47. A barcode 5140 permits a document to be scanned directly into a patient chart. A hotspot with favorites 5145 is shown as described with reference to FIG. 37. A typing hotspot 5150 is shown, and is a highlighted area wherein text may be typed that will both stored into a database included with the stored document image 5100. A signature stamp 5155 is also shown.

### The Hyperforms Toolbar

The HyperForms toolbar 5105 of FIG. 51 contains tools by which a template may be edited. These tools are represented by icons within the toolbar. FIG. 52 illustrates executable icons, along with names and descriptions, of the form of FIG. 51. A pen icon 5205 may be used in a basic writing option. A marker icon 5210 can be used for a thicker writing line. An eraser icon 5215 can be used to erase lines at a user's discretion as if using a pencil eraser. If using a mouse, a user can hold down the left mouse button or, if using a stylus, a user can keep the stylus point on the screen to erase. An erase section icon 5220 permits a user to click and drag around an area to erase contents within the area. An erase page icon permits erasing of all markings on a page. A stroke eraser icon 5230 is used to erase a last stroke made. Continual selection of the stroke eraser icon 5230 will erase each previous stroke. An insert text icon 5235 allows a user to add a text note to the document. A font size icon 5240 opens a pull donw menu for changing font size. A stamp icon 5245 allows a user to stamp a check mark stamp, X mark stamp, my signature, etc. An open new form icon 5250 permits a user to bring up a list of templates to add. A delete icon 5255 deletes a page being currently viewed when clicked. A save and close icon 5260 permits saving a closing. A “save and . . . ” icon 5265 offers additional savings options to a user.

### Text Tool

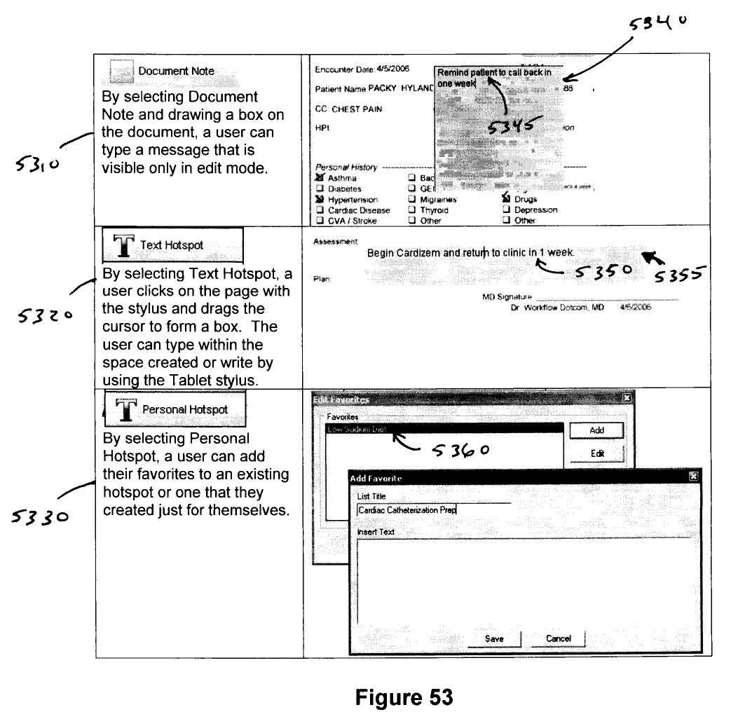

FIG. 53 illustrates a text tool that allows a user to insert a document note 5310, a text hotspot 5320 and a personal hotspot 5330, and may be used for editing the form 5100 of FIG. 51. By selecting Document Note 5310 and drawing a box 5340 on a document, a user can type a message that is visible only in an edit mode.

In general, a hotspot is an interactive area on a document. A user can type or write in the area, or the user can select from a preconfigured list of choices. Two types of hotspots include text hotspots 5320 and personal hotspots 5330.

Text Hotspots 5320 allow the insertion of plain text 5350. A text hotspot 5320 may be created on a per session basis. Preferably, a text hotspot 5320 is configured to be created for a specific document, and for a specific user. A text hotspot 5320 can be configured so that once saved, it cannot be edited. By selecting Text Hotspot 5320, a user can click on a page with a stylus and drag a cursor to form a box 5355. A user can type within the space created or write by using the Tablet stylus.

Personal Hotspots 5330 are preferably configured to be available to a specific user that adds his or her favorites 5360. Such favorites 5360 can be added to global hotpots (see above) or personal hotspots 5330, as illustrated in FIG. 53. Personal Hotspots 5330 are preferably unique to the user who creates them. Once created by a user, a personal hotspot will preferably show for that specific user. By selecting Personal Hotspot 5330, a user can add his or her favorites to an existing hotspot or one that they created just for themselves.

### Stamp

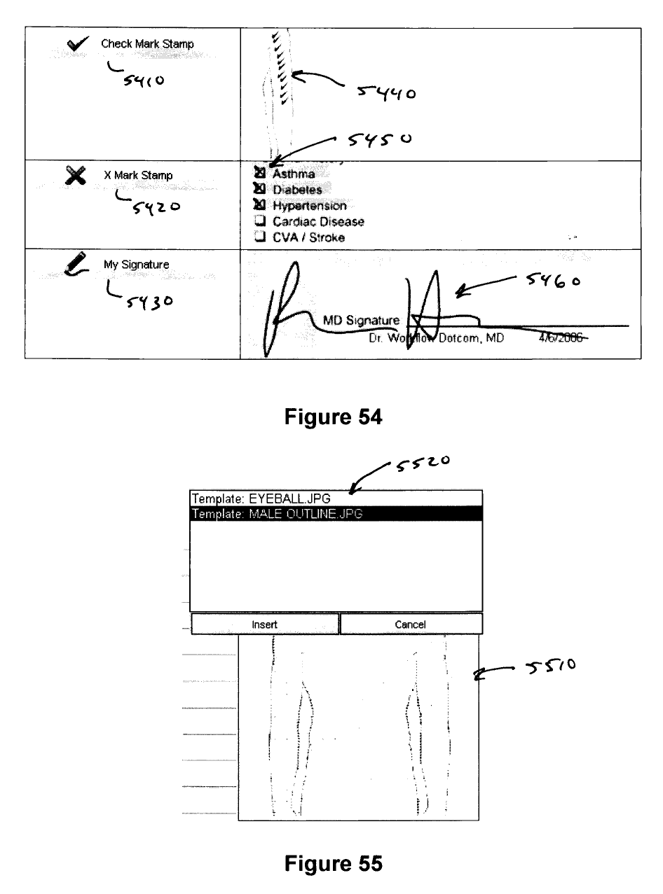

FIG. 54 illustrates a check mark stamp 5410, a X mark stamp 5420, and a signature stamp 5430 for editing the form of FIG. 51. The stamp icon 5245 of FIG. 52 allows a user to select a check mark 5440 or a X mark 5450 for notating the document. The stamp icon 5245 also preferably allows the user to stamp a signature 5460 onto a document.

### Inserting an Image

FIG. 55 illustrates a user interface for inserting an image 5510 into the form of FIG. 51. There may be image hotspots 5510 that exist on a document that allow a user to insert an existing template 5520 or image 5510 into a document that he or she is currently working on. The user can then write on the image and this can later be imported into a summary document. A user could click for example in the upper right hand corner of the image hotspot 5510 to activate a list of possible template images to insert.

### Link Hotspots

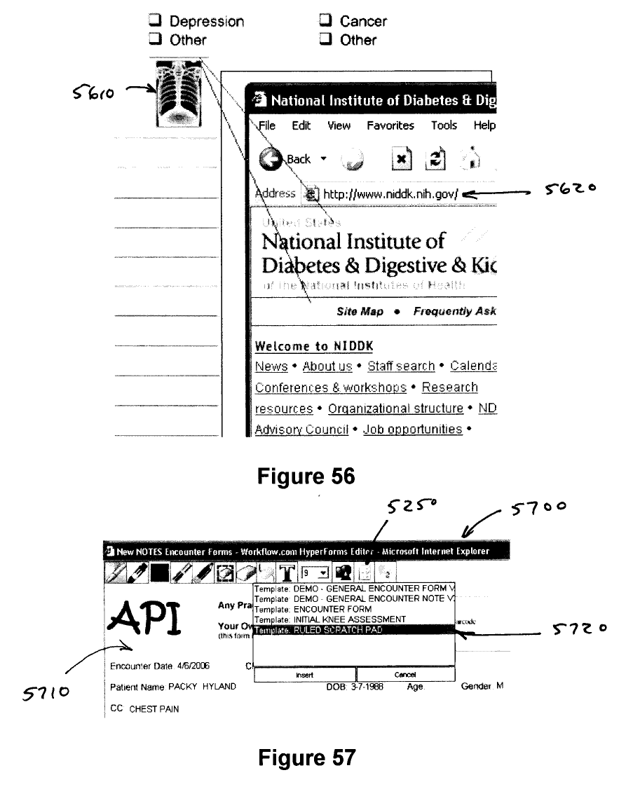

FIG. 56 illustrates a user interface for configuring a link hotspot into the form of FIG. 51. A user can click an icon 5610 or text, and that will take the user to either a web address 5620 or a new document (depending on the configuration). That is, hotspots 5610 can be configured for a document that connect to an internet site or a new document.

### Inserting a Template

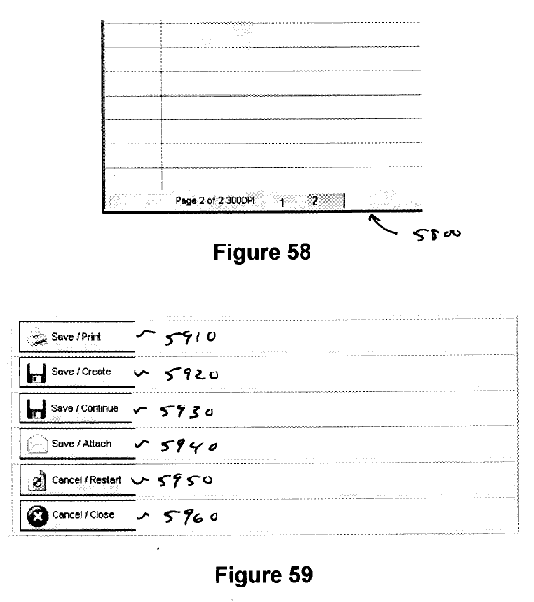

FIGS. 57-58 illustrate a user interface 5700 for inserting a template 5800 into a form 5710, and adding it as a last page. That is, while working within a document 5710 or form 5710, a user can insert one or more templates 5800 that become additional pages to the initial document. A user can click on the Insert Template icon 5250 (see FIGS. 51 and 52, insert form icon 5250) and then can choose the desired template from a menu list 5720 to insert. Once inserted, the template 5800 is preferably added to the last page of the document as an additional page.

### Save Options

FIG. 59 illustrates icons corresponding to combination save options that may be used when editing the form of FIG. 51. Once the user has finished their writing or typing on the template, or editing by adding hotspots or hotspot information or otherwise, the user may select any of a variety of save combination functions, including save/print 5910, save/create 5920, save/continue 5930, save/attach 5940, cancel/restart 5950 and cancel/close 5960. A user or developer can also customize the Save Menu to provide “Save and Set Status” functionality. This way, the user can save a document with a particular status, such as “Need Review” or “Awaiting Signature” (from another person), or “Completed”.

### Document Storage & Data Extraction

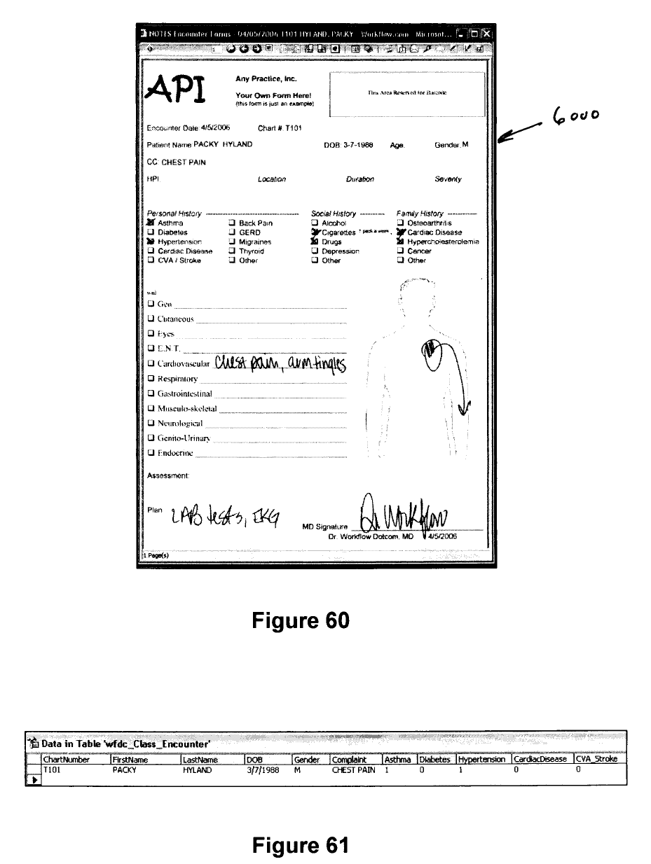

FIG. 60 illustrates the form of FIG. 51 as a saved image 6000 within an electronic system in accordance with a preferred embodiment. Documents created or edited in HyperForms™ may be advantageously stored as images in the system in various formats including, but not limited to, Group 4 Compressed TIF or JPEG. The saving of images 6000 is in addition to the ability of the system to save hotspot data. Upon opening a document, the software application for opening the document automatically runs and the document is displayed in a Document View Window. For example, when a Microsoft Word document is opened, Microsoft Word may automatically run. The strokes (handwriting) as well as configured hotspot data elements are rendered to the physical image that is stored to the server for archival/viewing purposes.

Hotspot data may be stored in the database as “re-editable”, and eventually the document can be “signed off” on which forces hotspot data to be burned to the image and become no longer editable. In addition to storing the physical “burned” image file to the server, discrete data elements (defined by the hotspot configuration) are also saved back to the database, allowing for future aggregation and quick searching of the data, as well as editing in some circumstances.

### Data Capture

Captured data is stored to a database. FIG. 61 illustrates how data may be captured from the form of FIG. 51 and stored to a database in accordance with a preferred embodiment. Configured data fields are determined by the organization or user. Fields illustrated at FIG. 61 include chart number, first and last name of a patient, date of birth (DOB), gender, complaint, and whether the patient has asthma, diabetes, hypertension, cardiac disease and/or CVA stroke. This data can be mined and reported on at a later time and used for outcome reporting and research.

### Image Capture

In addition to standard text data, hotspots can also capture a region of the image (including any handwriting in that region) to be saved to the server as a discrete data instance to the document and later be embedded in various documents within the system (including but not limited to Microsoft Word and Adobe PDF documents).

### Audio Capture

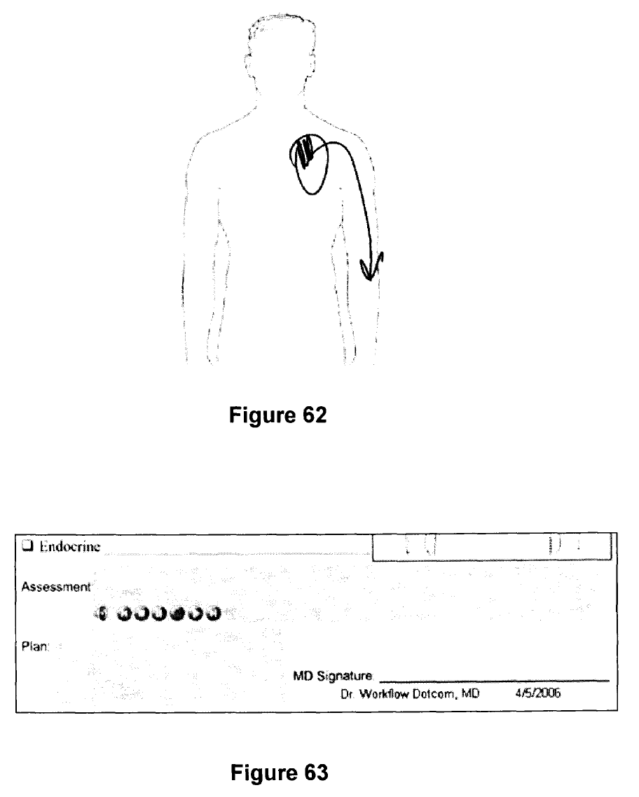

HyperForms™ can also capture audio data related to a hotspot as a discrete data instance related to the document. This audio stream can be later played back, edited, or even embedded in another document. FIGS. 62 and 63 illustrate image and audio capture, respectively, in accordance with a preferred embodiment.

### Data Value Retrieval in Workflow

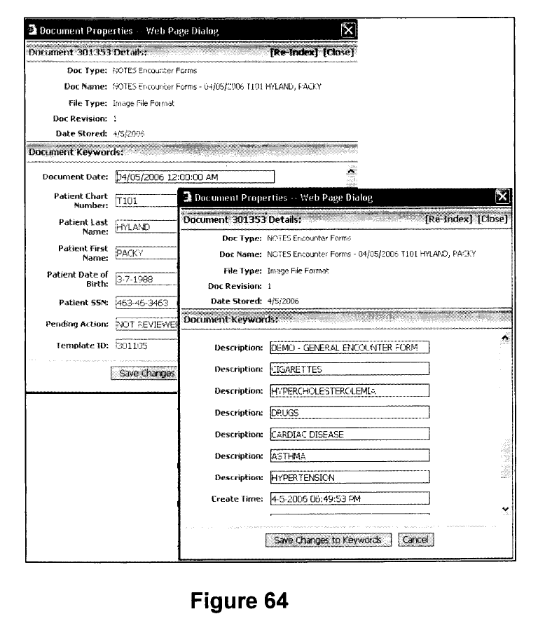

Data values can be stored when using HyperForms™. Any data that is typed, handwritten and converted to text, selected from a dropdown list of choices, or ticked off will be stored within the database. These values are associated with the document. FIG. 64 illustrates data values associated with the form of FIG. 51 being stored to a database of an electronic system in accordance with a preferred embodiment.

### Data Search in Database

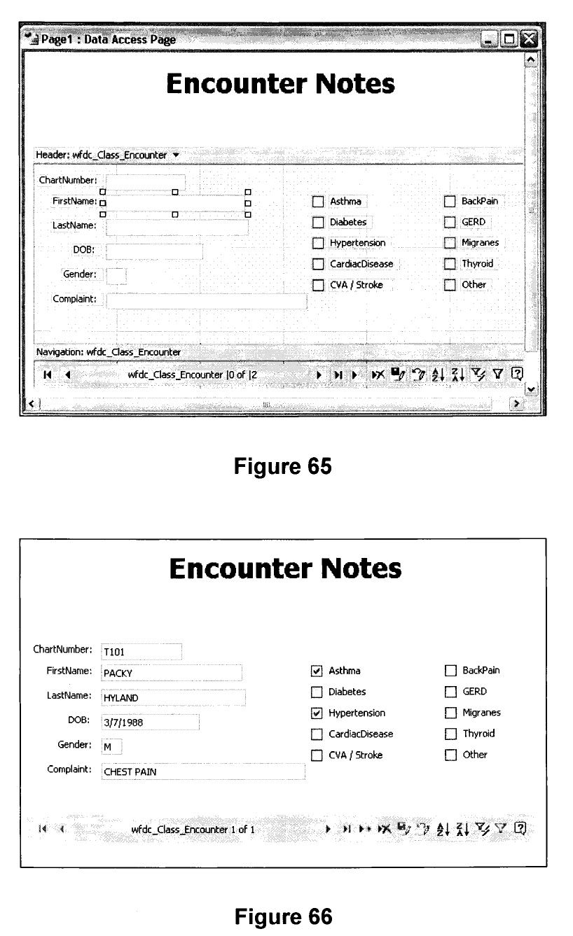

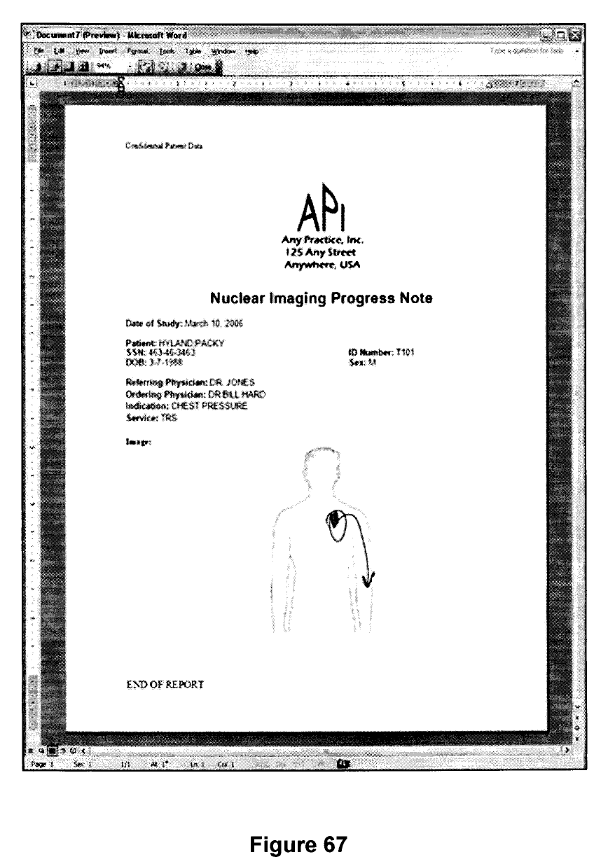

Data that is stored in the SQL database can be easily reported on by using industry standard SQL reporting tools, Microsoft Access and Crystal Reports. FIGS. 65 and 66 respectively illustrates a blank encounter note and an encounter note automatically filled in with information entered at the form of FIG. 51 and stored to a database of an electronic system in accordance with a preferred embodiment. The information that has been automatically filled into the form illustrated at FIG. 66 is the same exemplary information indicated in the data table of FIG. 61. That is, the report on the SQL database illustrated at FIG. 61 can result in a report as illustrated in FIG. 66.

### Data Mapped to a Microsoft Word® Document

After discrete data elements are collected via HyperForms™, Electronic Form, or other method within the system, these data elements can be used as context to create other forms, or even aggregated and embedded into another document in various industry standard formats including but not limited to Microsoft Word and Adobe PDF documents. FIG. 67 illustrates a document generated using in-part information entered at the form of FIG. 51 and stored to a database of an electronic system in accordance with a preferred embodiment. The information includes patient and attending physician information, as well as an image.

### Hyperforms Review Mode

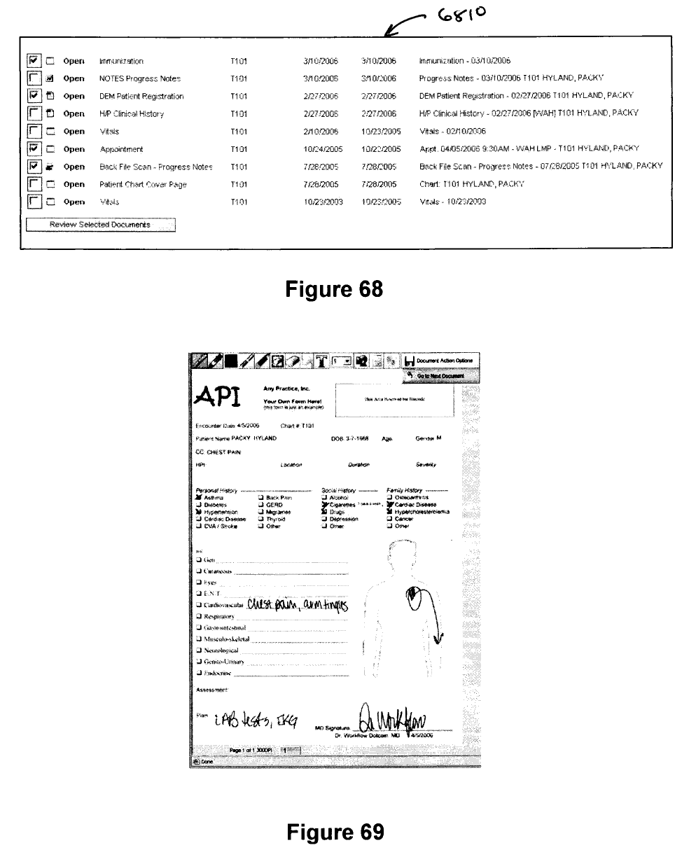

Review mode enables a user to quickly review a collection of documents in the system, via a “rapid fire” approach. FIG. 68 illustrates a user interface 6810 for reviewing documents within an electronic system in accordance with a preferred embodiment. The documents are either scanned images of paper documents that are to be reviewed or they can be documents that are created within the software using HyperForms™, or both.

The documents exist within a report 6810. One, some or all of the documents can be selected to appear in successive order. This allows a user to quickly ink on the first document and save the revision, and then can immediately view and edit any successive document.

### Writing on a Tablet in Review Mode

Paper documents that were once reviewed using an ink pen now can be quickly reviewed on a Tablet PC. Using a pen (stylus) allows users to “ink”, or write, on the documents just like in the paper world. Incoming paper documents can be scanned into the Workflow software to be converted into electronic documents. FIG. 69 illustrates editing a transaction-specific form that has been stored earlier following a transaction or patient encounter. The editing can take place in review mode by retrieving the document to a display of an electronic system in accordance with a preferred embodiment.

After selecting the electronic documents, the first document appears on the screen. A user can write, type, stamp a signature, insert a template or image on the document.

After editing the document, the user can select from a list of actions. For example, save and move to the next document, save and internal message, save and set pending action, save and place in another user's review report, etc. Upon completion of selecting an action, the next document opens.

The present invention is not limited to the embodiments described above herein, which may be amended or modified without departing from the scope of the present invention.

In methods that may be performed according to preferred embodiments herein and that may have been described above and/or claimed below, the operations have been described in selected typographical sequences. However, the sequences have been selected and so ordered for typographical convenience and are not intended to imply any particular order for performing the operations.

In addition, any references cited above herein, in addition to the background and summary of the invention sections, are hereby incorporated by reference into the detailed description of the preferred embodiments as disclosing alternative embodiments.

What is claimed is:

1. A method of generating a library of forms for documenting business transactions, comprising:
a. scanning an existing paper form or importing an externally-residing existing electronic form as a new form in an electronic system;
b. customizing the new form including adding one or more editable hotspots to the new form;
c. storing and indexing the new form within the system such that it is accessible to authorized users of the system, and
d. wherein the new form is uploadable as a transaction-specific form to be displayed on a portable processor-based device, and edited at any hotspot or elsewhere on the form or both, and then stored into the system.

2. The method of claim 1, further comprising automatically filling pre-stored transaction-specific information into the transaction-specific form.

3. The method of claim 2, wherein the transaction-specific information comprises a customer's name, date of birth, or gender, or the current date, or combinations thereof.

4. The method of claim 1, wherein the transaction-specific information is automatically filled when a customer is selected from a customer list residing on the system.

5. The method of claim 1, further comprising communicating data from the transaction-specific form to another processor-based device.

6. The method of claim 1, further comprising inserting information into the transaction-specific form by choosing among options from a preconfigured list of favorites provided at one of the hotspots.

7. The method of claim 1, further comprising adding text into the transaction-specific form at a text hotspot.

8. The method of claim 7, wherein the text added is saved into a database.

9. The method of claim 1, further comprising inserting a predetermined marking by executing a tick hotspot.

10. The method of claim 9, wherein the executing comprises maneuvering a cursor to the tick hotspot and clicking or tapping with a stylus at the tick hotspot on a display of the portable processor-based device.

11. The method of claim 9, further comprising adding information corresponding to the tick hotspot into the transaction-specific form as a result of executing the tick hotspot.

12. The method of claim 11, wherein the tick hotspot information added is saved into a database.

13. The method of claim 1, further comprising adding text into the transaction specific form at an arbitrary location on the transaction-specific form.

14. The method of claim 1, further comprising extracting one or more selected items from the transaction-specific form for insertion into another document.

15. The method of claim 1, wherein the downloadable form is editable by adding handwriting to the transaction-specific form.

16. The method of claim 1, further comprising capturing information with at least one hotspot.

17. The method of claim 16, further comprising:
e. extracting said information inserted at said at least one hotspot;
f. storing said extracted information at a database; and
g. creating a formatted note based on said extracted information.

18. The method of claim 1, further comprising creating a new hotspot within the transaction-specific form during a business transaction.

19. The method of claim 1, wherein the customizing includes configuring at least one hotspot for adding to the new form.

20. The method of claim 1, wherein the customizing includes adding a preconfigured hotspot to the new form.

21. A method of documenting a business transaction, comprising:
a. loading a form including one or more hotspots from an electronic system that comprises one or more scanned paper forms or imported externally-residing existing electronic forms or combinations thereof;
b. displaying the loaded form on a portable processor-based device;
c. generating a transaction-specific form by editing the loaded form during a business transaction including capturing information with at least one hotspot; and
d. storing the transaction-specific form as an image, and also discretely storing the information captured with the at least one hotspot.

22. The method of claim 21, further comprising automatically filling pre-stored transaction-specific information into the transaction-specific form.

23. The method of claim 22, wherein the transaction-specific information comprises a customer's name, date of birth, or gender, or the date, or combinations thereof.

24. The method of claim 21, further comprising communicating data from the transaction-specific form to another processor-based device.

25. The method of claim 21, further comprising:
e. extracting said information inserted at said at least one hotspot;
f. storing said extracted information at a database; and
g. creating a formatted note based on said extracted information.

26. The method of claim 21, further comprising capturing information into the transaction-specific form by choosing among options from a preconfigured list of favorites provided at one of the hotspots.

27. The method of claim 21, further comprising adding text into the transaction-specific form at a text hotspot.

28. The method of claim 27, wherein the text added is saved into a database.

29. The method of claim 21, further comprising inserting a predetermined marking by executing a tick hotspot.

30. The method of claim 29, wherein the executing comprises maneuvering a cursor to the tick hotspot and clicking or tapping with a stylus at the tick hotspot on a display of the portable processor-based device.

31. The method of claim 29, further comprising adding information corresponding to the tick hotspot into the transaction-specific form as a result of executing the tick hotspot.

32. The method of claim 31, wherein the tick hotspot information added is saved into a database.

33. The method of claim 21, further comprising adding text into the transaction specific form at an arbitrary location on the transaction-specific form.

34. The method of claim 33, wherein the arbitrary location is not within a hotspot and not discretely saved to a database.

35. The method of claim 21, further comprising extracting one or more selected items from the transaction-specific form for insertion into another document.

36. The method of claim 21, wherein the editing comprises adding handwriting to the transaction-specific form.

37. The method of claim 21, further comprising editing said form at a link icon hotspot, image hotspot or audio hotspot, or combinations thereof.

38. The method of claim 21, further comprising adding a signature stamp to the transaction-specific form.

39. The method of claim 21, further comprising executing a link hotspot for retrieving another document or network location.

40. The method of claim 21, further comprising inserting a template as one or more additional pages into the transaction-specific form.

41. The method of claim 21, further comprising selecting a save option that also prints the form, uploads a new copy of the same form, reloads the form for continued editing, attached the forms to an email, or sets a status of the form, or combinations thereof.

42. A portable processor-based device, comprising a processor and a display, and a stylus, mouse or keypad, or combinations thereof, for editing a form uploaded from a generated a library of forms for documenting a business transaction, the device further comprising one or more digital storage media having instructions embedded therein for programming the processor to perform a method according to any of claims 1-41

43. One or more digital storage media having instructions embedded therein for programming one or more processors to perform a method according to any of claims 1-41.
